(19) United States
(12) Patent Application Publication
(10) Pub. No.: US 2008/0063208 A1
(43) Pub. Date: Mar. 13, 2008

(54) Data Transmitting Apparatus

(76) Inventors: Tsuyoshi Ikushima, Nara (JP); Satoshi Furusawa, Osaka (JP); Masaru Fuse, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/665,684

(22) PCT Filed: Nov. 4, 2005
(86) PCT No.: PCT/JP05/20308

§ 371 Date: Apr. 17, 2007

(30) Foreign Application Priority Data
Nov. 10, 2004 (JP) 2004-326411
Nov. 15, 2004 (JP) 2004-330980
Feb. 24, 2005 (JP) 2005-049460

(51) Int. Cl. H04L 9/08; H04L 9/28

(52) U.S. Cl. 380/278; 380/45

(57) ABSTRACT

A data communication system is provided in which a time required for a wiretapper to decrypt an encrypted text is significantly increased so that concealment is improved. In a data transmitting apparatus (17105), a multilevel encoding part (111) switches a plurality of key information to generate a multilevel code sequence in which the average values of signal levels are different, and then combines the generated multilevel code sequence with information data to generate a multilevel signal having a level corresponding to the combination of the two signal levels. A light modulating part (125) converts the multilevel signal into a modulated signal of a predetermined modulation scheme and transmits it. In a data receiving apparatus (17205), a light demodulating part (219) demodulates the received modulated signal into the multilevel signal. A multilevel decoding part (212) switches a plurality of key information to generate a multilevel code sequence in which the average values of signal levels are different, and then identifies the multilevel signal based on this generated multilevel code sequence to regenerate the information data.

### TECHNICAL FIELD

The present invention relates to an apparatus for performing concealed communication that avoids unauthorized wiretapping and interception by a third person. More specifically, the present invention relates to an apparatus performing data communication in a state that a particular encoding/decoding (modulation/demodulation) method is selected and set up between authorized transmitting and receiving persons.

### BACKGROUND ART

In the conventional art, in order that communication should be performed between specified persons, a method is adopted in which key information for coding/decoding is shared in transmitting and receiving and in which on the basis of the key information, mathematical arithmetic operation and inverse operation are performed on the information data (plaintext) to be transmitted so that concealed communication is achieved FIG. 32 is a block diagram showing a configuration of a conventional data transmitting apparatus according to this method. In FIG. 32, the conventional data communication system has a configuration that a data transmitting apparatus 90001 is connected to a data receiving apparatus 90002 via a transmission path 913. The data transmitting apparatus 90001 comprises an encoding part 911 and a modulating part 912. The data receiving apparatus 90002 comprises a demodulating part 914 and a decoding part 915. In the conventional data communication system, when information data 90 and first key information 91 are inputted to the encoding part 911 while second key information 96 is inputted to the decoding part 915, information data 98 is outputted from the decoding part 915. The operation of the conventional data communication system is described below with reference to FIG. 32.

In the data transmitting apparatus 90001, the encoding part 911 encodes (encryption) information data 90 on the basis of the first key information 91. The modulating part 912 modulates in a predetermined modulation scheme the information data encoded by the encoding part 911, and transmits as a modulated signal 94 to the data receiving apparatus 90002 via the transmission path 913. In the data receiving apparatus 90002, the demodulating part 914 demodulates by a predetermined demodulation method the modulated signal 94 transmitted via the transmission path 913, and outputs it. The decoding part 915 decodes the signal demodulated by the demodulating part 914 (decryption) on the basis of the second key information 96 shared with the encoding part 911, and regenerates the original information data 98.

A wiretapping action by a third person is described below with reference to a wiretapper data receiving apparatus 90003. In FIG. 32, the wiretapper data receiving apparatus 90003 comprises a wiretapper demodulating part 916 and a wiretapper decoding part 917. The wiretapper demodulating part 916 wiretaps the modulated signal (information data) transmitted between the data transmitting apparatus 90001 and the data receiving apparatus 90002, and demodulates by a predetermined demodulation method the wiretapped modulated signal. On the basis of third key information 99, the wiretapper decoding part 917 tries decoding of the signal demodulated by the wiretapper demodulating part 916. Here, since the wiretapper decoding part 917 does not share the key information with the encoding parts 911, the decoding of the signal demodulated by the wiretapper demodulating part 916 is tried on the basis of the third key information 99 different from the first key information 91. Thus, the wiretapper decoding part 917 cannot correctly decode the signal demodulated by the wiretapper demodulating part 916, and cannot regenerate the original information data.

Such a mathematical encryption technique based on mathematical arithmetic operations (also referred to as calculation encryption or software encryption) can be applied to access systems and the like as described, for example, in Patent Document 1. That is, in a PON (Passive Optical Network) configuration in which an optical signal transmitted from one optical transmitter is branched by an optical coupler and then distributed individually to optical receivers of a plurality of optical subscribers' homes, signals directed to another subscriber other than a desired optical signal are inputted to each optical receiver. Thus, information data for each subscriber is encrypted using mutually different key information, so that mutual leakage and wiretapping of the information are avoided, so that security data communication is realized.

[Patent Document 1] Japanese Laid-Open Patent Publication No. H9-205420

### DISCLOSURE OF THE INVENTION

### Problems to be Solved by the Invention

Nevertheless, in the conventional data communication system based on the mathematical encryption technique, even in the case that the key information is not shared, the wiretapper can decrypt in principle when arithmetic operations using key information of all the possible combinations are tried (a brute force attack) on the encrypted text (modulated signal or encrypted information data) or alternatively when a special analytic algorithm is applied on it. In particular, since improvement in the processing speed of computers in recent years is remarkable, there has been a problem that when a computer employing new principles such as quantum computers could be realized in the future, the encrypted text would be wiretapped within a limited time.

Thus, an object of the present invention is to provide a data communication system having high concealment in which the time required for a wiretapper to analyze an encrypted text is increased significantly so that an astronomical amount of computation is caused.

### Solution to the Problems

The present invention addresses a data transmitting apparatus for performing encrypted communication. Then, in order to achieve the above-mentioned object, the data transmitting apparatus of the present invention comprises a multilevel encoding part and a modulating part. The multilevel encoding part receives predetermined key information and information data, and generates a multilevel signal that varies in a signal level substantially in a random number manner. The modulating part generates a modulated signal of a predetermined modulation scheme on the basis of the multilevel signal. The predetermined key information is a plurality of key information. The multilevel encoding part includes a key information switching part, a multilevel code generating part and a multilevel processing part. The key information switching part switches and outputs a plurality of key information at a predetermined timing. The multilevel code generating part generates a multilevel code sequence which varies in a signal level substantially in a random number manner and in which the average values of the signal levels are different in respective key information outputted from the key information switching part, on the basis of the key information outputted from the key information switching part. The multilevel processing part combines the multilevel code sequence and the information data in accordance with predetermined processing, and generates a multilevel signal having a level corresponding to a combination of the two signal levels.

The modulated signal is generated by modulating light waves with the multilevel signal.

Preferably, the key information switching part switches and outputs the plurality of key information to the multilevel code generating part at predetermined time intervals.

The key information switching part stores in advance a sequence of switching the plurality of key information, and switches and outputs the plurality of key information to the multilevel code generating part in accordance with the stored sequence.

Preferably, the key information switching part switches the plurality of key information at time intervals shorter than a response speed of a gain change of an erbium doped fiber amplifier.

Further, the present invention addresses also a data receiving apparatus for performing encrypted communication. Then, in order to achieve the above-mentioned object, the data receiving apparatus of the present invention comprises a demodulating part and a multilevel decoding part. The demodulating part demodulates a modulated signal of a predetermined modulation scheme and outputs it as a multilevel signal. The multilevel decoding part receives predetermined key information and the multilevel signal, and outputs information data. The predetermined key information is a plurality of key information. Specifically, the multilevel decoding part includes a key information switching part, a multilevel code sequence generating part and a decision part. The key information switching part switches and outputs a plurality of key information at a predetermined timing. The multilevel code sequence generating part generates a multilevel code sequence which varies in a signal level substantially in a random number manner and in which the average values of the signal levels are different in respective key information outputted from the key information switching part, on the basis of the key information outputted from the key information switching part. The decision part receiving the multilevel signal, and deciding the logic of the information data on the basis of the multilevel code sequence, and outputs information data.

Preferably, the modulated signal is generated by modulating light waves with a multilevel signal.

Preferably, the key information switching part switches and outputs the plurality of key information to the multilevel code sequence generating part at predetermined time intervals.

Further, the data receiving apparatus may further comprise an average value detecting part for calculating an average value of the multilevel signal level for each predetermined time, and determining key information for regenerating the information data, as regeneration key information by using the calculated average value and the average value of the levels of the multilevel signal that appears in correspondence to each of the plurality of key information.

The average value detecting part includes: an integration circuit for outputting an integration value obtained by integrating the level of the multilevel signal for each predetermined time; an average value calculating part for calculating an average value of the multilevel signal level from the integration value; and a control signal generating part that holds in advance an average value of the levels of the multilevel signal appearing in correspondence to each of the plurality of key information, then determines, as being the regeneration key information, key information of the case that the absolute value of a difference between the calculated average value and the average value held in advance becomes the minimum, and generates a control signal for uniquely identifying the regeneration key information. The key information switching part outputs key information identified with the control signal, as the regeneration key information to the multilevel code sequence generating part.

Preferably, the key information switching part stores in advance a sequence of switching and outputting the plurality of key information, and switches and outputs the plurality of key information to the multilevel code sequence generating part in accordance with the stored sequence.

Further, the data receiving apparatus may further comprise an average value detecting part for calculating an average value of the multilevel signal level for each predetermined time, and determining key information for regenerating the information data, as regeneration key information by using the calculated average value, the sequence stored in advance and the average value of the levels of the multilevel signal that appears in correspondence to each of the plurality of key information.

The average value detecting part includes: an integration circuit for outputting an integration value obtained by integrating the level of the multilevel signal for each predetermined time; an average value calculating part for calculating an average value of the multilevel signal level from the integration value; and a control signal generating part that holds in advance an average value of the levels of the multilevel signal appearing in correspondence to each of the plurality of key information, then selects key information of the case that the absolute value of a difference between the calculated average value and the average value held in advance becomes the minimum, then determines, as being the regeneration key information, key information to be used next to the key information selected from the sequence stored in advance and generates a control signal for uniquely identifying the regeneration key information. The key information switching part outputs key information identified with the control signal, as the regeneration key information to the multilevel code sequence generating part.

Further, the data receiving apparatus may further comprise an average value detecting part that calculates an average value of the multilevel signal level for each predetermined time and that, when the calculated average value is a value within a predetermined range, generates a control signal for instructing output of the multilevel code sequence, and outputs it to the multilevel code sequence generating part. In this case, the multilevel code sequence generating part generates the multilevel code sequence only at the time of receiving the control signal.

The average value detecting part includes: an integration circuit for outputting an integration value obtained by integrating the level of the multilevel signal for each predetermined time; an average value calculating part for calculating an average value of the levels of the multilevel signal from the integration value; and a control signal generating part for generating a control signal when the level of the calculated average value falls within a predetermined range.

Further, the present invention addresses also a data communication system in which a data transmitting apparatus and a data receiving apparatus perform encrypted communication. Then, in order to achieve the above-mentioned object, the data transmitting apparatus of the present invention comprises a multilevel encoding part and a modulating part. The multilevel encoding part receives predetermined first key information and information data, and generates a first multilevel signal that varies in a signal level substantially in a random number manner. The modulating part generates a modulated signal of a predetermined modulation scheme on the basis of the first multilevel signal. The first predetermined key information is a plurality of key information. Specifically, the multilevel encoding part includes a first key information switching part, a first multilevel code generating part and a multilevel processing part. The first key information switching part switches and outputs the plurality of key information at a predetermined timing. The first multilevel code generating part generates a first multilevel code sequence which varies in a signal level substantially in a random number manner and in which the average values of the signal levels are different in respective key information outputted from the first key information switching part, on the basis of the key information outputted from the first key information switching part. The multilevel processing part combines the first multilevel code sequence and the information data in accordance with predetermined processing, and converts it into a first multilevel signal having a level corresponding to a combination of the two signal levels.

Further, the data receiving apparatus of the present invention comprises a demodulating part and a multilevel decoding part. The demodulating part demodulates a modulated signal of a predetermined modulation scheme and outputs a second multilevel signal. The multilevel decoding part receives predetermined second key information and the second multilevel signal, and outputs information data. The second key information is a plurality of key information. The multilevel decoding part includes a second key information switching part, a second multilevel code generating part and a decision part. The second key information switching part switches and outputs the plurality of key information at a predetermined timing. The second multilevel code generating part generates a second multilevel code sequence which varies in a signal level substantially in a random number manner and in which the average values of the signal levels are different in respective key information outputted from the second key information switching part, on the basis of the key information outputted from the second key information switching part. The decision part receives the second multilevel signal, and decides the logic of the information data on the basis of the second multilevel code sequence, and outputs information data.

Preferably, the modulated signal is generated by modulating light waves with a multilevel signal.

Preferably, the first key information switching part switches and outputs the plurality of key information to the first multilevel code generating part at predetermined time intervals.

Further, the first key information switching part may store in advance a sequence of switching the plurality of key information, and switch and output the plurality of key information to the first multilevel code generating part in accordance with the stored sequence.

Further, the first key information switching part may switch the plurality of key information at time intervals shorter than a response speed of a gain change of an erbium doped fiber amplifier.

Preferably, the second key information switching part switches and outputs the plurality of key information to the second multilevel code sequence generating part at predetermined time intervals.

The data receiving apparatus may further comprise an average value detecting part for calculating an average value of the multilevel signal level for each predetermined time, and determining key information for regenerating the information data, as regeneration key information by using the calculated average value and the average value of the levels of the multilevel signal that appears in correspondence to each of the plurality of key information.

Preferably, the average value detecting part includes: an integration circuit for outputting an integration value obtained by integrating the level of the multilevel signal for each predetermined time; an average value calculating part for calculating an average value of the multilevel signal level from the integration value; and a control signal generating part that holds in advance an average value of the levels of the multilevel signal appearing in correspondence to each of the plurality of key information, then determines, as being the regeneration key information, key information of the case that the absolute value of a difference between the calculated average value and the average value held in advance becomes the minimum, and generates a control signal for uniquely identifying the regeneration key information. The key information switching part outputs key information identified with the control signal, as the regeneration key information to the multilevel code sequence generating part.

The second key information switching part stores in advance a sequence of switching and outputting the plurality of key information, and switches and outputs the plurality of key information to the second multilevel code sequence generating part in accordance with the stored sequence.

The data receiving apparatus may further comprise an average value detecting part for calculating an average value of the multilevel signal level for each predetermined time, and determining key information for regenerating the information data, as regeneration key information by using the calculated average value, the sequence stored in advance and the average value of the levels of the multilevel signal that appears in correspondence to each of the plurality of key information.

The average value detecting part includes: an integration circuit for outputting an integration value obtained by integrating the level of the multilevel signal for each predetermined time; an average value calculating part for calculating an average value of the multilevel signal level from the integration value; and a control signal generating part that holds in advance an average value of the levels of the multilevel signal appearing in correspondence to each of the plurality of key information, then selects key information of the case that the absolute value of a difference between the calculated average value and the average value held in advance becomes the minimum, then determines, as being the regeneration key information, key information to be used next to the key information selected from the sequence stored in advance and generates a control signal for uniquely identifying the regeneration key information. The second key information switching part outputs key information identified with the control signal, as the regeneration key information to the second multilevel code sequence generating part.

The data receiving apparatus may further comprise an average value detecting part that calculates an average value of the multilevel signal level for each predetermined time and that, when the calculated average value is a value within a predetermined range, generates a control signal for instructing output of the second multilevel code sequence, and outputs it to the second multilevel code sequence generating part. The second multilevel code sequence generating part generates the second multilevel code sequence only at the time of receiving the control signal.

The average value detecting part includes: an integration circuit for outputting an integration value obtained by integrating the level of the multilevel signal for each predetermined time; an average value calculating part for calculating an average value of the levels of the multilevel signal from the integration value; and a control signal generating part for generating a control signal when the level of the calculated average value falls within a predetermined range.

### EFFECT OF THE INVENTION

According to the data communication system of the present invention, information data is encoded and modulated into a multilevel signal on the basis of key information. Then, the signal is transmitted. The received multilevel signal is demodulated and decoded on the basis of the same key information, so that the signal-to-noise power ratio of the multilevel signal is brought into an appropriate value. Thus, in the data communication system permits high concealment data communication in which the time required for a wiretapper to analyze an encrypted text is increased significantly so that an astronomical amount of computation is caused.

Further, when the information data is encoded into a multilevel signal, the data transmitting apparatus of the present invention switches the plurality of key information. Further, the data receiving apparatus of the present invention decodes the multilevel signal by using the same key information as the key information used in the data transmitting apparatus. Thus, the data communication system can perform data communication with higher concealment. Further, the data transmitting apparatus of the present invention transmits a modulated signal in which the average value of the levels of the multilevel signal varies at predetermined time intervals. In a case that the predetermined time interval is set to be shorter than the response speed of gain change in an erbium doped fiber amplifier, when a third person amplifies an intercepted modulated signal by using an erbium doped fiber amplifier, the waveform of the amplified modulated signal can be distorted. This increases difficulty in the determination of the levels of the multilevel signal by the third person.

Further, the data receiving apparatus of the present invention calculates the average value of the levels of the multilevel signal at predetermined time intervals. The data receiving apparatus holds in advance an average value of the levels of the multilevel signal appearing in correspondence to each of the plurality of key information, then compares the average value of the levels of the calculated multilevel signal with the average value of the multilevel signal level possessed in advance, and thereby determines key information used in generating of the multilevel signal. Thus, in the data communication system of the present invention, the necessity is avoided that the timing of switching the key information should be synchronized in the data transmitting apparatus and the data receiving apparatus.

Further, the data transmitting apparatus switches a plurality of key information at predetermined time intervals, thereby generates a multilevel signal in which the average values of signal levels are different in respective key information, and transmits the generated multilevel signal to a plurality of data receiving apparatuses. The data receiving apparatuses decode the multilevel signal on the basis of the inputted key information only when the average value of the levels of the multilevel signal generated on the basis of the inputted key information agrees with the average value of the levels of the received multilevel signal. This allows the data transmitting apparatus to transmit encrypted data to a plurality of data receiving apparatuses.

### BRIEF DESCRIPTION OF THE DRAWINGS

FIG. 1 is a block diagram showing a configuration of a data communication system according to a first embodiment of the present invention.

FIG. 2 is a schematic diagram describing a waveform of a transmission signal of a data communication system according to a first embodiment of the present invention.

FIG. 3 is a schematic diagram describing a waveform of a transmission signal of a data communication system according to a first embodiment of the present invention.

FIG. 4 is a schematic diagram describing transmission signal quality of a data communication system according to a first embodiment of the present invention.

FIG. 5 is a block diagram showing a configuration of a data communication system according to a second embodiment of the present invention.

FIG. 6 is a block diagram showing a configuration of a data communication system according to a third embodiment of the present invention.

FIG. 7 is a schematic diagram describing a transmission signal parameter of a data communication system according to a fourth embodiment of the present invention.

FIG. 8 is a block diagram showing a configuration of a data communication system according to a fifth embodiment of the present invention.

FIG. 9 is a diagram showing levels and an average value of a multilevel code sequence generated on the basis of key information A or key information B.

FIG. 10 is a diagram showing the relation between an average input light level and gain characteristics of an erbium doped fiber amplifier.

FIG. 11 is a diagram describing distortion in a light modulated signal 46 amplified by a wiretapper.

FIG. 12 is a block diagram showing a configuration of a data communication system according to a sixth embodiment of the present invention.

FIG. 13 is a block diagram showing an example of a configuration of an average value detecting part 222.

FIG. 14 is a diagram describing operation of an average value detecting part 222.

FIG. 15 is a block diagram showing a configuration of a data communication system according to a seventh embodiment of the present invention.

FIG. 16 is a block diagram showing a configuration of a data communication system according to an eighth embodiment of the present invention.

FIG. 17 is a diagram showing an exemplary waveform of an information data group inputted to an N-adic encoding part 131.

FIG. 18 is a diagram showing an exemplary waveform of an N-adic encoded signal 52 outputted from an N-adic encoding part 131.

FIG. 19 is a diagram showing an exemplary waveform of a multilevel signal 13 outputted from a multilevel processing part 111b.

FIG. 20 is a diagram describing an example of decision operation in a decision part 212b.

FIG. 21 is a diagram showing a waveform of a multilevel signal 15 onto which noise is superimposed.

FIG. 22 is a block diagram showing an exemplary configuration of a data communication system according to a ninth embodiment of the present invention.

FIG. 23 is a block diagram showing another exemplary configuration of a data communication system according to a ninth embodiment of the present invention.

FIG. 24 is a block diagram showing a configuration of a data communication system according to a tenth embodiment of the present invention.

FIG. 25 is a schematic diagram describing a signal waveform outputted from a multilevel encoding part 111.

FIG. 26 is a block diagram showing a configuration of a data communication system according to an eleventh embodiment of the present invention.

FIG. 27 is a schematic diagram describing a transmission signal waveform of a data communication system according to an eleventh embodiment of the present invention.

FIG. 28 is a block diagram showing a configuration of a data communication system according to a twelfth embodiment of the present invention.

FIG. 29 is a block diagram showing a configuration of a data communication system according to a thirteenth embodiment of the present invention.

FIG. 30A is a block diagram showing an exemplary configuration of a data communication system in which features of embodiments of the present invention are combined.

FIG. 30B is a block diagram showing an exemplary configuration of a data communication system in which features of embodiments of the present invention are combined.

FIG. 30C is a block diagram showing an exemplary configuration of a data communication system in which features of embodiments of the present invention are combined.

FIG. 31A is a block diagram showing an exemplary configuration of a data communication system in which features of embodiments of the present invention are combined.

FIG. 31B is a block diagram showing an exemplary configuration of a data communication system in which features of embodiments of the present invention are combined.

FIG. 32 is a block diagram showing a configuration of a conventional data communication system.

### DESCRIPTION OF THE REFERENCE CHARACTERS

10, 18 information data
11, 16, 91, 96, 99 key information
12, 17 multilevel code sequence
13, 15 multilevel signal
14, 94 modulated signal
110 transmission path
111 multilevel encoding part
111a first multilevel code generating part
111b multilevel processing part
111c first key information switching part
112, 122, 123, 912 modulating part
113 first data inverting part
114 noise controlling part
114a noise generating part
114b combining part
118 dummy signal superimposing part
118a dummy generation code generating part
118b dummy signal generating part
118c superimposing part
125 light modulating part
120 amplitude controlling part
120a first amplitude signal generating part
120b amplitude modulating part
124 wave mixing part
125 light modulating part
126 optical transmission path
127 light branching part
131, 132 N-adic encoding part
134 synchronization signal generating part
135 multilevel processing controlling part
211, 914, 916 demodulating part
212, 218 multilevel decoding part
212a second multilevel code generating part
212b decision part
212c second key information switching part
213 second data inverting part
219, 225 light demodulating part
220, 221 N-adic decoding part
222, 226 average value detecting part
2221 integration circuit
2222 average value calculating part
2223 control signal generating part
233 synchronization signal regenerating part
234 decision controlling part
236 sub demodulating part
237 decision part
240 detecting part
241 amplitude controlling part
242 synchronization extracting part
914 encoding part
915, 917 decoding part
10101-19108 data transmitting apparatus
10201-19207 data receiving apparatus

### BEST MODE FOR CARRYING OUT THE INVENTION

### First Embodiment

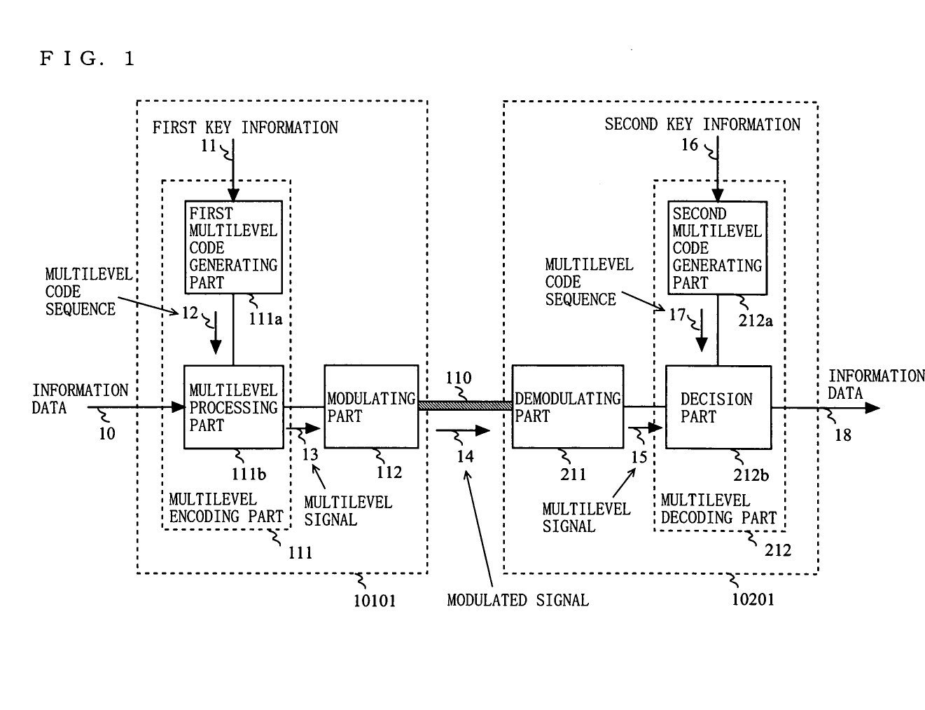

FIG. 1 is a block diagram showing a configuration of a data communication system according to a first embodiment of the present invention. In FIG. 1, the data communication system according to the first embodiment has a configuration that a data transmitting apparatus 10101 is connected to a data receiving apparatus 1020 via a transmission path 110. The data transmitting apparatus 10101 comprises a multilevel encoding part 111 and a modulating part 112. The multilevel encoding part 111 includes a first multilevel code generating part 111a and a multilevel processing part 111b. The data receiving apparatus 10201 comprises a demodulating part 211 and a multilevel decoding part 212. The multilevel decoding part 212 includes a second multilevel code generating part 212a and a decision part 212b. The transmission path 110 may employ a metal line such as a LAN cable and a coaxial cable or alternatively an optical waveguide such as a fiber optical cable. Further, the transmission path 110 is not restricted to a wire cable such as a LAN cable, and may be a free space through which a radio signal can propagate.

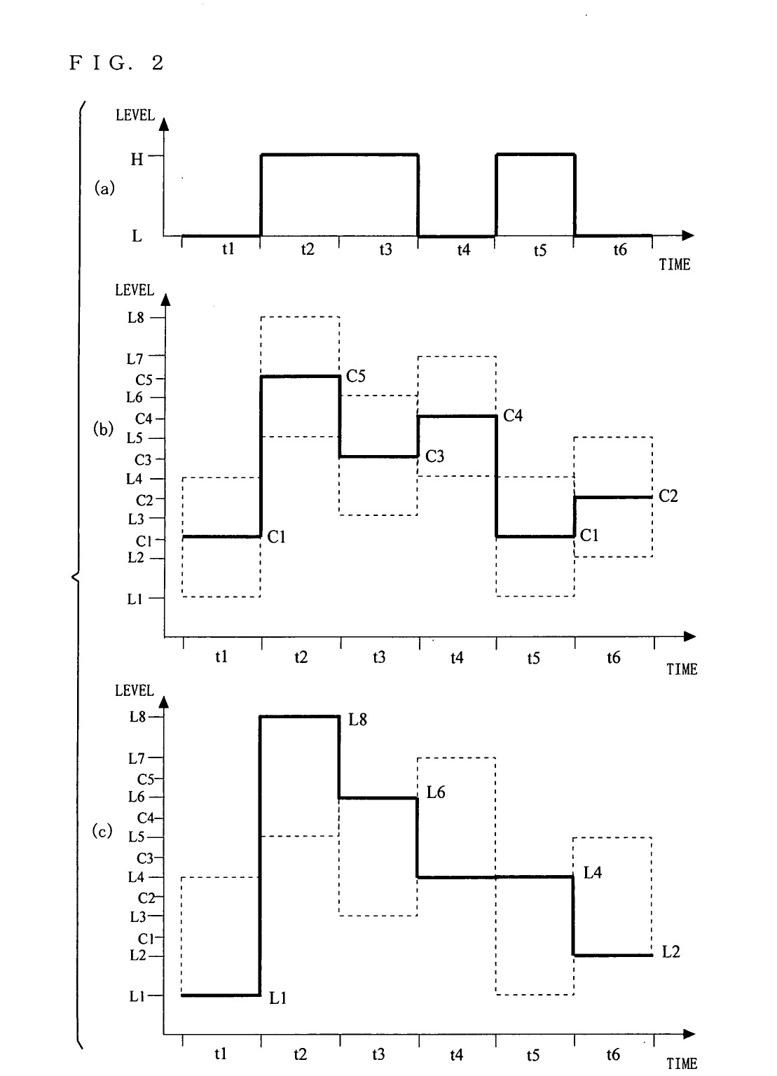

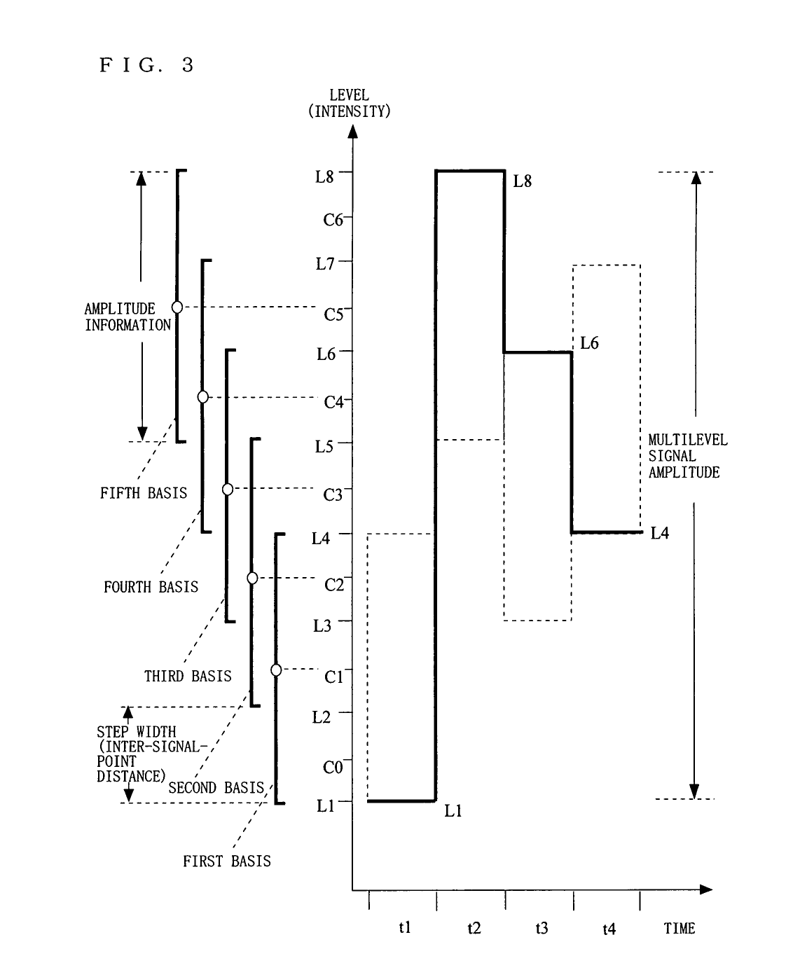

FIGS. 2 and 3 are schematic diagrams describing the waveform of a modulated signal outputted from the modulating part 112. The operation of the data communication system according to the first embodiment is described below with reference to FIGS. 1 to 3.

On the basis of first predetermined key information 11 defined in advance, the first multilevel code generating part 111a generates a multilevel code sequence 12 (FIG. 2(b)) that varies in the signal level substantially in a random number manner. The multilevel processing part 111b receives the multilevel code sequence 12 (FIG. 2(b)) and information data 10 (FIG. 2(a)), and combines both signals in accordance with a predetermined procedure so as to generate a multilevel signal 13 (FIG. 2(c)) having a level uniquely corresponding to the combination of the two signal levels. For example, when the level of the multilevel code sequence 12 varies like c1/c5/c3/c4 for time slots t1/t2/t3/t4, the multilevel processing part 111b adds the information data 10 with adopting this multilevel code sequence 12 as a bias level, so as to generate the multilevel signal 13 that varies in the level like L1/L8/L6/L4.

Here, as shown in FIG. 3, the amplitude of the information data 10 is referred to as the “information amplitude”. The total amplitude of the multilevel signal 13 is referred to as the “multilevel signal amplitude”. The sets (L1, L4)/(L2, L5)/(L3, L6)/(L4, L7)/(L5, L8) of the levels that can be taken by the multilevel signal 13 in correspondence to the levels c1/c2/c3/c4/c5 of the multilevel code sequence 12 are referred to as the first to the fifth “bases”, respectively. The minimum inter-signal-point distance of the multilevel signal 13 is referred to as the “step width”.

The modulating part 112 modulates the multilevel signal 13 in a predetermined modulation scheme, and transmits it as a modulated signal 14 to the transmission path 110. The demodulating part 211 demodulates the modulated signal 14 transmitted via the transmission path 110, and regeneratese the multilevel signal 15. The second multilevel code generating part 212a shares, in advance, second key information 16 which is the same as the first key information 11. Then, on the basis of the second key information 16, the second multilevel code generating part 212a generates a multilevel code sequence 17 corresponding to the multilevel code sequence 12. With adopting the multilevel code sequence 17 as the thresholds, the decision part 212b receives the multilevel signal 15, and decides the logic of the information data 18, and regenerates the information data 18. Here, the modulated signal 14 of a predetermined modulation scheme transmitted and received between the modulating part 112 and the demodulating part 211 via the transmission path 110 is obtained when electromagnetic waves (electromagnetic field) or light waves are modulated by the multilevel signal 13.

Here, as described above, in addition to the method of generating the multilevel signal 13 by addition processing between the multilevel code sequence 12 and the information data 10, the multilevel processing part 111b may generate the multilevel signal 13 by using any other method. For example, the multilevel processing part 111b may perform amplitude modulation on the levels of the multilevel code sequence 12 on the basis of the information data 10 so as to generate the multilevel signal 13. Alternatively, the multilevel processing part 111b may read serially the levels of the multilevel signal 13 corresponding to the combination of the information data 10 and the multilevel code sequence 12 from a memory storing in advance the levels of the multilevel signal 13, so as to generate the multilevel signal 13.

Further, in FIGS. 2 and 3, the levels of the multilevel signal 13 are represented as eight steps. However, the levels of the multilevel signal 13 are is not limited to this representation. Further, the information amplitude is represented as three times or an integer multiple of the step width of the multilevel signal 13. However, the information amplitude is not limited to this representation. The information amplitude may be any integer multiple of the step width of the multilevel signal 13, and need not be an integer multiple. Further, in relation to this, in FIGS. 2 and 3, each level of the multilevel code sequence 12 is arranged approximately at the center between the levels of the multilevel signal 13. However, each level of the multilevel code sequence 12 is not limited to this arrangement. For example, each level of the multilevel code sequence 12 need not be arranged approximately at the center between the levels of the multilevel signal 13, and may agree with each level of the multilevel signal 13. Further, in the description given above, it is premised that the multilevel code sequence 12 and the information data 10 have the same change rate with each other and are in a synchronized relation. However, the change rate of one of them may be faster (or slower) than the change rate of the other. Further, they may be asynchronous.

Wiretapping operation for the modulated signal 14 by a third person is described next. A third person serving as a wiretapper is expected to decrypt the modulated signal 14 by using a configuration similar to that of the data receiving apparatus 10201 owned by the authenticated receiving person or alternatively a data receiving apparatus of yet higher performance (for example, a wiretapper data receiving apparatus). The wiretapper data receiving apparatus demodulates the modulated signal 14 and thereby regenerates the multilevel signal 15. However, the wiretapper data receiving apparatus does not share the key information with the data transmitting apparatus 10101, and hence cannot generate the multilevel code sequence 17 from the key information like in the data receiving apparatus 10201. Thus, the wiretapper data receiving apparatus cannot perform binary determination of the multilevel signal 15 on the basis of the multilevel code sequence 17.

Wiretapping operation adoptable in such a case is a method that identification is performed simultaneously on the entire levels of the multilevel signal 15 (referred to as a “brute force attack” in general). That is, the wiretapper data receiving apparatus prepares thresholds between all signal points that the multilevel signal 15 can take, then performs simultaneous determination of the multilevel signal 15, and analyzes the determination result so as to try to extract correct key information or information data. For example, the wiretapper data receiving apparatus adopts as the thresholds the levels c0/c1/c2/c3/c4/c5/c6 of the multilevel code sequence 12 shown in FIG. 2, and performs multilevel determination of the multilevel signal 15 so as to try to extract correct key information or information data.

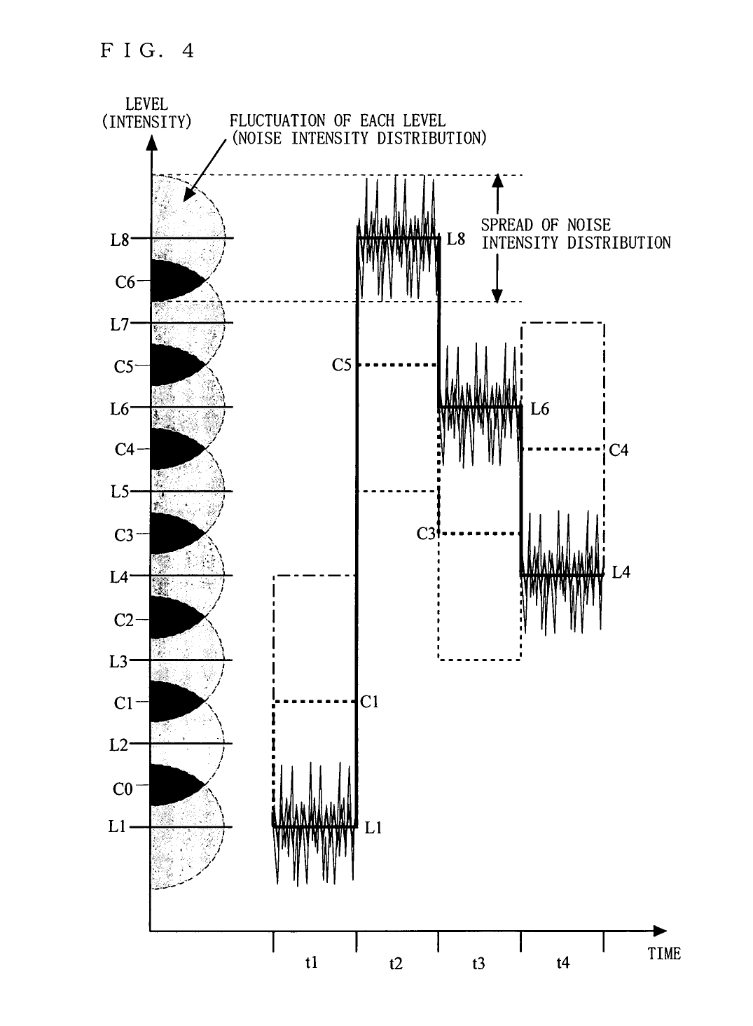

Nevertheless, in the actual transmission system, noise occurs owing to various factors. Then, this noise is superimposed on the modulated signal 14, so that the levels of the multilevel signal 15 vary in time and instantaneously as shown in FIG. 4. In such a case, the SN ratio (signal-to-noise intensity ratio) of the to-be-determined signal (multilevel signal 15) to be determined by the authenticated receiving person (data receiving apparatus 10201) is determined by the ratio between the information amplitude and the noise amount of the multilevel signal 15. In contrast, the SN ratio of the to-be-determined signal (multilevel signal 15) to be determined by the wiretapper data receiving apparatus is determined by the ratio between the step width and the noise amount of the multilevel signal 15.

Thus, on condition that the noise level in the to-be-determined signal is the same, the SN ratio of the to-be-determined signal becomes smaller in the wiretapper data receiving apparatus than in the data receiving apparatus. That is, the transmission characteristics (error rate) degrades. Accordingly, using this characteristics, the data communication system can induce identification errors in the brute force attack using all thresholds by a third person, and thereby cause difficulty in the wiretapping. In particular, when the step width of the multilevel signal 15 is set up in the same order or smaller in comparison with the noise amplitude (spread of noise intensity distribution), the data communication system can bring the multilevel determination by the third person to be practically impossible, and can achieve ideal wiretapping prevention.

Here, when the modulated signal 14 is electromagnetic waves such as a radio signal, the noise superimposed on the to-be-determined signal (multilevel signal 15 or modulated signal 14) may be thermal noise (Gaussian noise) present in the space field, electronic parts and the like. When light waves are used, fluctuation (quantum noise) in the number of photons at the time of photon generation may be employed in addition to the thermal noise. In particular, a signal using quantum noise cannot be treated by signal processing such as recording and duplication. Thus, when the data communication system sets up the step width of the multilevel signal 15 with reference to the noise amount, wiretapping by a third person becomes impossible so that absolute security is ensured in the data communication.

As described above, according to the present embodiment, when the information data to be transmitted is encoded as a multilevel signal, the inter-signal-point distances of the multilevel signal are appropriately set up relative to the noise amount in such a manner that wiretapping by a third person should become impossible. As such, a security-improved data communication system can be provided that imparts critical degradation to the received signal quality at the time of wiretapping by a third person, and causes difficulty in decryption and decoding of the multilevel signal by the third person.

### Second Embodiment

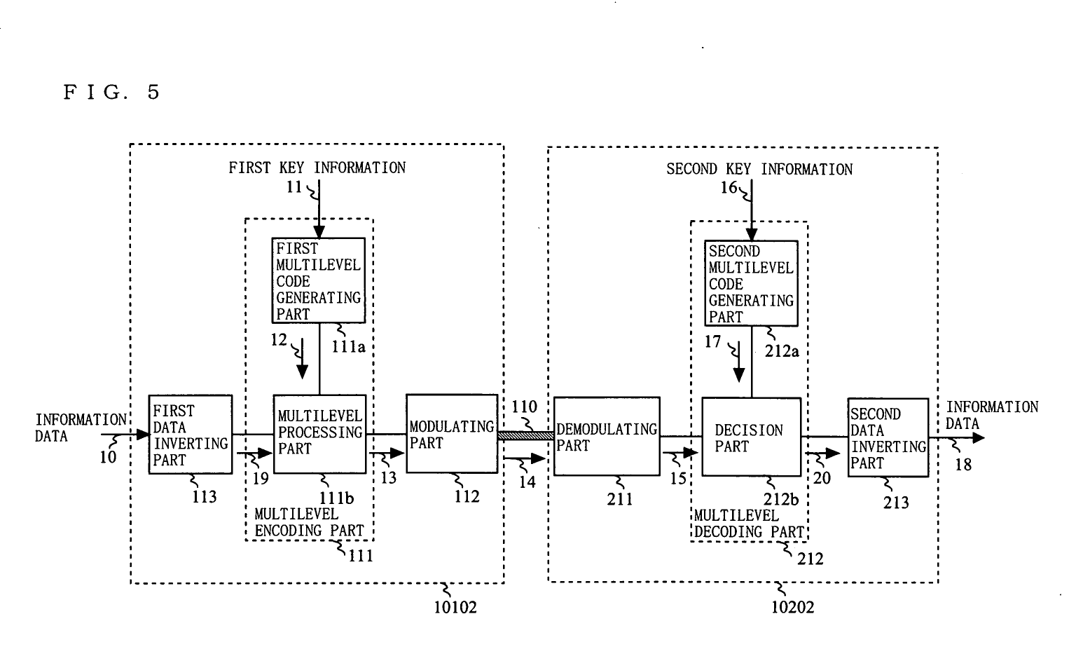

FIG. 5 is a block diagram showing a configuration of a data communication system according to a second embodiment of the present invention. In FIG. 5, in comparison with the data communication system (FIG. 1) according to the first embodiment, in the data communication system according to the second embodiment, the data transmitting apparatus 10102 further comprises a first data inverting part 113 while the data receiving apparatus 10202 further comprises a second data inverting part 213. The data communication system according to the second embodiment is described below. Here, the configuration of the present embodiment is similar to that of the first embodiment (FIG. 1). Thus, blocks that perform the same operation as the first embodiment are designated by the same reference numerals, and their description is omitted.

The first data inverting part 113 does not fix the correspondence relation between “0/1” in the information data 10 shown in FIG. 2(a) and “Low/High”, and changes the correspondence relation approximately at random by a predetermined procedure. For example, similarly to the multilevel encoding part 111, the first data inverting part 113 performs arithmetic operation of exclusive logical sum (Exclusive OR) between a random number sequence (pseudo-random number sequence) generated on the basis of a predetermined initial value and the information data 10, and outputs the arithmetic operation result to the multilevel encoding part 111. For the data outputted from the multilevel decoding part 212, the second data inverting part 213 changes the correspondence relation between “0/1” and “Low/High” by a procedure inverse to that of the first data inverting part 113. For example, the second data inverting part 213 shares the same initial value as the initial value owned by the first data inverting part 113, and performs arithmetic operation of exclusive logical sum between a random bit flipping sequence generated on the basis of this and the data outputted from the multilevel decoding part 212, so as to regenerate the arithmetic operation result as the information data 18.

As described above, according to the present embodiment, the information data to be transmitted is reversed approximately at random, so that complexity as encryption in the multilevel signal is increased. This causes further difficulty in decryption and decoding of the multilevel signal by a third person, so that a security data communication system can be provided.

### Third Embodiment

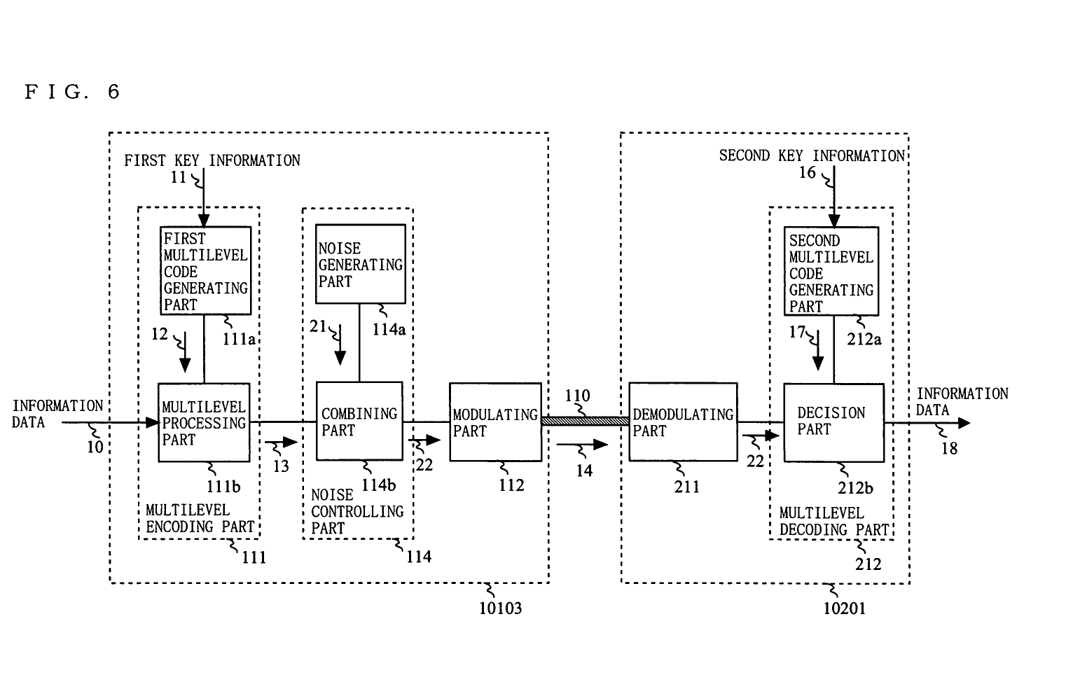

FIG. 6 is a block diagram showing a configuration of a data communication system according to a third embodiment of the present invention. In FIG. 6, in comparison with the data communication system (FIG. 1) according to the first embodiment, in the data communication system according to the third embodiment, the data communication system 10103 further comprises a noise controlling part 114. The noise controlling part 114 includes a noise generating part 114a and a combining part 114b. The data communication system according to the third embodiment is described below. Here, the configuration of the present embodiment is similar to that of the first embodiment (FIG. 1). Thus, blocks that perform the same operation as the first embodiment are designated by the same reference numerals, and their description is omitted.

The noise generating part 114a generates predetermined noise. The combining part 114b combines the multilevel signal 13 and noise, and outputs it to the modulating part 112. That is, the noise controlling part 114 intentionally generates level fluctuation in the multilevel signal 13 described with reference to FIG. 4, and controls the SN ratio of the multilevel signal 13 into an arbitrary value. Here, as described above, the noise generated by the noise generating part 114a is thermal noise, quantum noise, or the like. Further, the multilevel signal in which noise is combined (superimposed) is referred to as a noise superimposed multilevel signal.

As described above, according to the present embodiment, information data to be transmitted is encoded as a multilevel signal, and the SN ratio of the encoded multilevel signal is controlled arbitrarily. As such, a security-improved data communication system can be provided that imparts critical degradation to the received signal quality at the time of wiretapping by a third person, and causes yet further difficulty in decryption and decoding of the multilevel signal by the third person.

### Fourth Embodiment

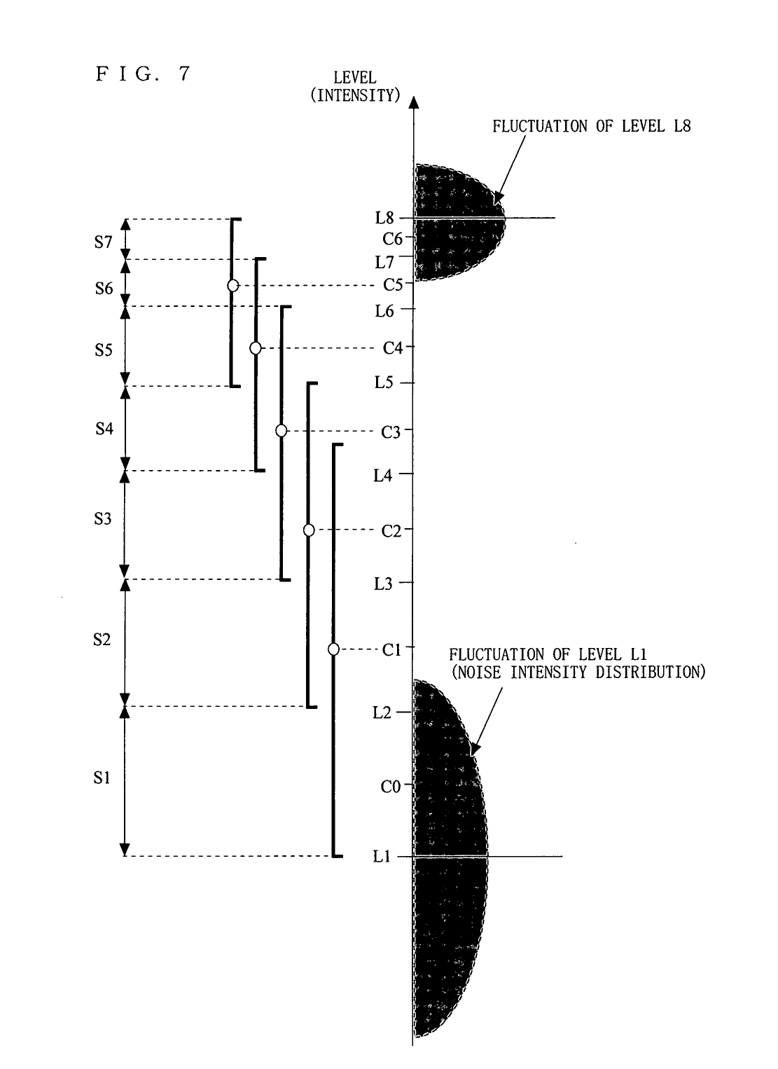

FIG. 7 is a schematic diagram describing a transmission signal parameter of a data communication system according to a fourth embodiment of the present invention. The data communication system according to the fourth embodiment has a configuration similar to that of the first embodiment (FIG. 1) or the third embodiment (FIG. 6). The data communication system according to the fourth embodiment of the present invention is described below with reference to FIG. 7.

Referring to FIG. 1 or 6, the multilevel encoding part 111 sets up each step width (S1 to S7) of the multilevel signal 13 in accordance with the fluctuation amount of each level (that is, noise intensity distribution superimposed on each level) as shown in FIG. 7. Specifically, the multilevel encoding part 111 distributes the inter-signal-point distances in such a manner that the SN ratios between two adjacent signal points of the to-be-determined signal (that is, the multilevel signal 15) inputted to the decision part 212b should be approximately homogeneous. Here, when the noise amount superimposed on each level of the multilevel signal 15 is the same, the multilevel encoding part 111 sets up each step width to be the same.

In general, as for the modulated signal 14 outputted from the modulating part 112, when a light intensity modulated signal is assumed to be obtained when a semiconductor laser (LD) is employed as the light source, the fluctuation width (noise amount) of the modulated signal 14 varies depending on the levels of the multilevel signal 13 inputted to the LD. This is because the LD emits light on the basis of the principle of induced emission using spontaneous emission light as “seed light”. The noise amount is defined as the relative ratio of the amount of spontaneous emission light to the amount of induced emission light. Here, with increasing excitation rate (corresponding to the bias current injected into the LD), the ratio of the amount of induced emission light increases so that the noise amount decreases. On the contrary, with decreasing excitation rate, the ratio of the amount of spontaneous emission light increases so that the noise amount increases. Thus, as shown in FIG. 7, the multilevel encoding part 111 sets up the step width to be large in a region where the level of the multilevel signal is small, and sets up the step width to be small in a region where the level of the multilevel signal is large (that is, nonlinearly). As a result, the SN ratios between adjacent signal points of the to-be-determined signal are set up to be approximately homogeneous.

Further, also when a light modulated signal is used as the modulated signal 14, on condition that the above-mentioned noise by spontaneous emission light and the thermal noise used in the optical receiver are sufficiently small, the SN ratio of the received signal is determined mainly by shot noise. With this condition, the noise amount contained in the multilevel signal increases with increasing levels of the multilevel signal. Thus, on the contrary to the case of FIG. 7, the multilevel encoding part 111 sets up the step width to be small in a region where the level of the multilevel signal is small, and sets up the step width to be large in a region where the level of the multilevel signal is large. As a result, the SN ratios between adjacent signal points of the to-be-determined signal are set up to be approximately homogeneous.

As described above, according to the present embodiment, when the information data to be transmitted is encoded as a multilevel signal, the inter-signal-point distances of the multilevel signal are set up in such a manner that the SN ratios between adjacent signal points of the to-be-determined signal should be approximately homogeneous. As such, a security-improved data communication system can be provided that imparts critical degradation to the received signal quality at the time of wiretapping by a third person, and causes yet further difficulty in decryption and decoding of the multilevel signal by the third person.

### Fifth Embodiment

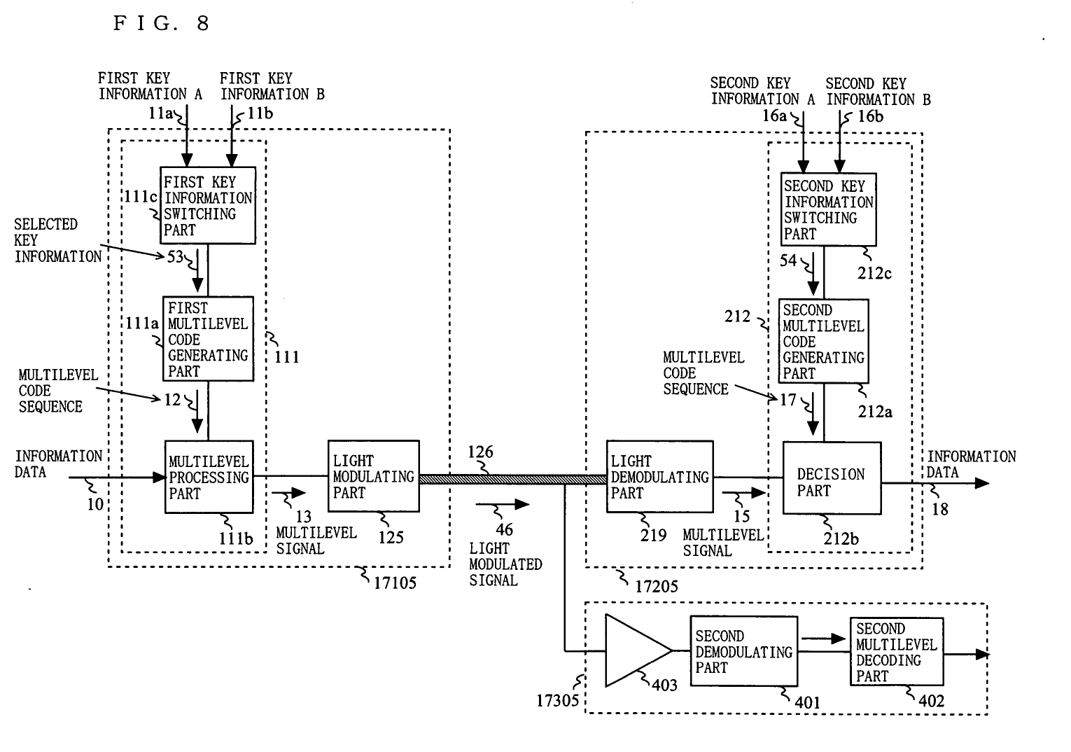

FIG. 8 is a block diagram showing a configuration of a data communication system according to a fifth embodiment of the present invention. In FIG. 8, the data communication system according to the fifth embodiment has a configuration that a data transmitting apparatus 17105 is connected to a data receiving apparatus 17205 via an optical transmission path 126. The data transmitting apparatus 17105 comprises a multilevel encoding part 111 and a light modulating part 125. The multilevel encoding part 111 includes a first multilevel code generating part 111a, a multilevel processing part 111b and a first key information switching part 111c. The data receiving apparatus 17205 comprises a light demodulating part 219 and a multilevel decoding part 212. The multilevel decoding part 212 includes a second multilevel code generating part 212a, a decision part 212b and a second key information switching part 212c.

Further, FIG. 8 shows a wiretapper data receiving apparatus 17305 for the purpose of describing wiretapping operation by a third person. Here, the wiretapper data receiving apparatus 17305 is not a configuration necessary in the data communication system of the present invention. The wiretapper data receiving apparatus 17305 comprises a light amplifying part 403, a light demodulating part 404 and a second multilevel decoding part 402.

In the data transmitting apparatus 17105, the first key information switching part 111c receives first key information A11a and first key information B11b. The first key information switching part 111c switches the first key information A11a and the first key information B11b at predetermined time intervals, and outputs the switched key information as selected key information 53. The first multilevel code generating part 111a generates a multilevel code sequence 12 from the inputted selected key information 53, and outputs the generated multilevel code sequence 12 to the multilevel encoding part 111b. The multilevel processing part 111b combines the information data 10 and the multilevel code sequence 12, and thereby generates a multilevel signal 13. The light modulating part 125 converts the multilevel signal 13 into a light modulated signal 46, and transmits it to the optical transmission path 126.

In the data receiving apparatus 17205, a light modulated signal 46 is inputted to the light demodulating part 219 via the optical transmission path 126. The light demodulating part 219 converts the inputted light modulated signal 46 into a multilevel signal 15. The multilevel signal 15 is inputted to the decision part 212b. The second key information switching part 212c receives second key information A16a and second key information B16b. The first key information A11a and the second key information A16a are the same key information. Further, the first key information B11b and the second key information B16b are the same key information.

The second key information switching part 212c switches the second key information A16a and the second key information B16b at predetermined time intervals, and outputs the switched key information as selected key information 54. The selected key information 54 is inputted to the second multilevel code generating part 212a. The second multilevel code generating part 212a generates a multilevel code sequence 17 on the basis of the selected key information 54. The multilevel code sequence 17 is inputted to the decision part 212b. Using the multilevel code sequence 17, the decision part 212b performs binary determination on the multilevel signal 15, and decodes the information data 18 from the multilevel signal 15.

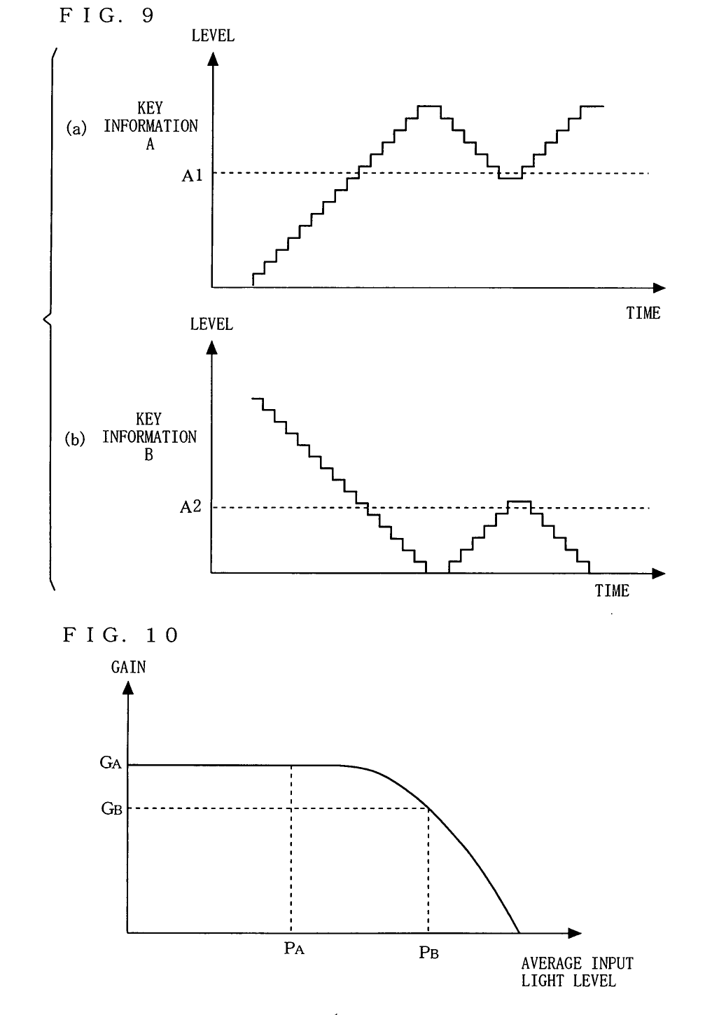

The key information used in the fifth embodiment is described below with reference to FIG. 9. FIG. 9 is a diagram showing levels and an average value of a multilevel code sequence generated on the basis of key information A or key information B. FIG. 9(a) is a diagram showing an example of level change in the multilevel code sequence 12 (referred to as “multilevel code sequence A”, hereinafter) generated on the basis of the first key information A11a and the second key information A16a (referred to as “key information A”, hereinafter). FIG. 9(b) is a diagram showing an example of level change in the multilevel code sequence 12 (referred to as “multilevel code sequence B”, hereinafter) generated on the basis of the first key information B11b and the second key information B16b (referred to as “key information B”, hereinafter). As shown in FIG. 9(a), in the multilevel code sequence A, higher levels have higher probability of appearance. On the other hand, as shown in FIG. 9(b), in the multilevel code sequence B, lower levels have lower probability of appearance. Thus, the average value A1 of the levels of the multilevel code sequence A is larger than the average value A2 of the levels of the multilevel code sequence B.

The multilevel code sequence 12 is generated at predetermined time intervals on the basis of any one of the key information A and the key information B. In the multilevel code sequence 12, the average value of the levels varies at predetermined time intervals. Thus, when the average value of the levels of the information data 10 is constant, the average value of the levels of the multilevel signal 13 varies at predetermined time intervals in correspondence to the change in the average value of the levels of the multilevel code sequence 12. Accordingly, the average value of the levels of the light modulated signal 46 also varies at predetermined time intervals similarly to the multilevel signal 13.

As such, the data transmitting apparatus 17105 generates the multilevel signal by using a plurality of key information. Thus, in comparison with the data communication system according to the first embodiment, data communication with higher concealment is achieved.

Next, expected wiretapping operation by a third person is described below. Here, the third person serving as a wiretapper is assumed not to have the key information A and the key information B.

Even when the light modulated signal 46 can be demodulated so that a multilevel signal 15 can be outputted, the third person serving as a wiretapper does not have the key information required for the multilevel determination. Thus, the multilevel signal 15 cannot be decoded, and hence the information data 18 cannot be regenerated. However, if the signal levels of the multilevel signal were acquired accurately, the third person could decrypt the key information from the multilevel signal 15 by brute force attack. In the binary determination of the multilevel signal performed by the authorized receiving person (i.e., the data receiving apparatus 17205), the SN ratio of the multilevel signal is determined by the ratio between the information amplitude and the noise contained in the multilevel signal. On the other hand, in the binary determination of the multilevel signal performed by the third person (i.e., the wiretapper data receiving apparatus 17305), the SN ratio of the multilevel signal is determined by the ratio between the inter-signal-point distance and the noise contained in the multilevel signal. Thus, the third person need to reduce the influence of the noise contained in the wiretapped multilevel signal in comparison with the authorized receiving person. Accordingly, the third person can install a light amplifying part 403 in the preceding stage of the second demodulating part 402 and thereby amplify the level of the multilevel signal.

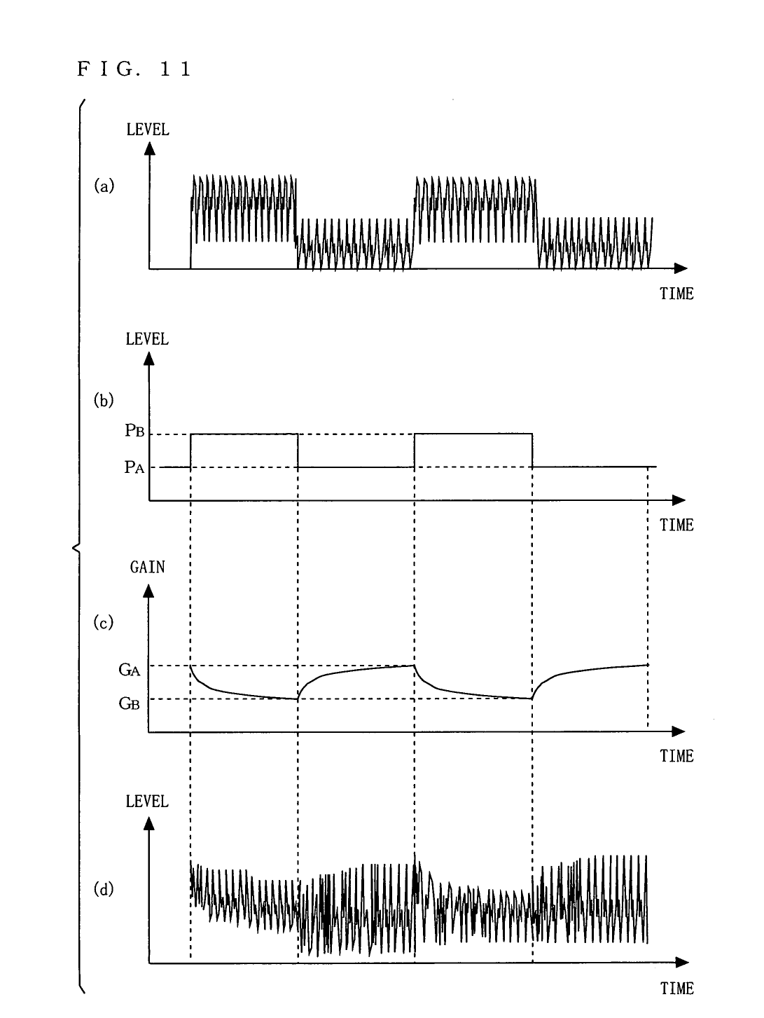

FIG. 10 is a diagram showing the relation between the average input light level and the gain characteristics of an erbium doped fiber amplifier (Erbium Doped Fiber Amplifier: EDFA) used generally in the light amplifying part. As shown in FIG. 10, the gain of the EDFA depends on the average level of the input light. The response speed of gain change in the EDFA is approximately a few kHz. Further, the response speed of gain change in the EDFA is sufficiently lower than the modulation rate of the inputted optical signal. Thus, when the average level of the input light to the EDFA does not vary, no distortion is generated in the output waveform of the EDFA. In contrast, when the average level of the input light to the EDFA varies at a speed comparable to the response speed of the EDFA, distortion arises in the output waveform. Thus, when the average level of the input light to the EDFA is changed artificially, distortion can be generated in the output waveform of the light amplifying part 403 employing the EDFA.

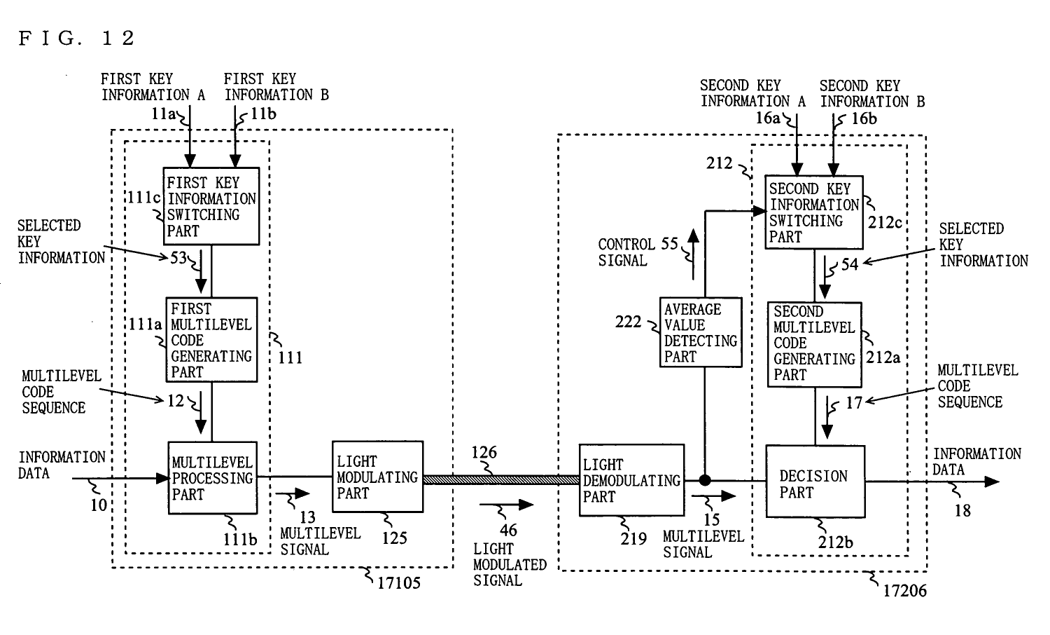

In the following description, the light amplifying part 403 (see FIG. 8) provided in the wiretapper data receiving apparatus 17305 is assumed to be an EDFA. As described above, the data transmitting apparatus 17105 switches the key information A and the key information B so as to generate the multilevel signal 13, and thereby outputs the light modulated signal 46 in which the level of the average value varies in time. FIG. 11 is a diagram describing distortion in a light modulated signal 46 amplified by a wiretapper. FIG. 11(a) is a diagram showing an example of the waveform of the light modulated signal 46. FIG. 11(b) is a diagram showing a time-dependent change in the average value of the levels of the light modulated signal 46 shown in FIG. 11(a). The time-dependent change in the average value of the levels of the light modulated signal 46 shown in FIG. 11(b) corresponds to the switching rate of the key information in the data transmitting apparatus 17105. FIG. 11(c) is a diagram showing a fluctuation in the gain of the light amplifying part 403 in a case that the switching rate of the key information in the data transmitting apparatus 17105 is close to the response speed of the gain of the light amplifying part 403. As a result of the change in the gain of the light amplifying part 403, the signal outputted from the light amplifying part 403 has a distorted waveform as shown in FIG. 11(d).

In the wiretapper data receiving apparatus 17305, the light demodulating part 404 demodulates the light modulated signal having a distorted waveform as shown in FIG. 11(d), and thereby regenerates the multilevel signal. Thus, the multilevel signal outputted from the light demodulating part 404 has a distorted waveform. The second multilevel decoding part 402 tries to identify the multi valued levels from the multilevel signal outputted from the light demodulating part 404. However, since the waveform of the multilevel signal is distorted, the multi valued levels of the multilevel signal cannot correctly be identified. Thus, the wiretapper cannot regenerate the information data from the multilevel signal. Further, the wiretapper cannot decrypt the key information also.

As described above, according to the data communication system of the present embodiment, the data transmitting apparatus 17105 switches a plurality of key information at predetermined time intervals, and generates a multilevel signal on the basis of the switched key information. The data receiving apparatus 17205 switch a plurality of key information at predetermined time intervals, and identifies the multilevel signal on the basis of the switched key information. As such, using a plurality of key information, the data communication system according to the present embodiment can transmit and receive an encrypted signal.

Further, the data transmitting apparatus 17105 switches the plurality of key information at time intervals shorter than the response speed of gain change in the erbium doped fiber amplifier. According to this, when a third person amplifies an intercepted modulated signal by using an erbium doped fiber amplifier, distortion can be caused in the waveform of the amplified modulated signal. This prevents the third person from determining the multi valued levels of the multilevel signal and decrypting the key information by brute force attack. Accordingly, in comparison with the data communication system according to the first embodiment, the data communication system according to the present embodiment can perform data communication with higher concealment.

Here, the present embodiment has been described for the case that two kinds of key information are used in the data communication system. However, the key information to be used is not limited to the two kinds. The data communication system according to the present embodiment may use three or more kinds of key information. Further, in the data communication system, the sequence of use of the key information may be defined in advance. In this case, the first key information switching part 111c and the second key information switching part 212c may have a circuit for generating the plurality of key information successively or alternatively a storage device for storing the plurality of key information.

### Sixth Embodiment

As described in the fifth embodiment, the average value of the levels of the multilevel signal depends on the average value of the levels of the multilevel code sequence generated on the basis of the key information. Thus, the data receiving apparatus according to the present embodiment uses the average value of the levels of the demodulated multilevel signal as control information concerning the switching of the plurality of key information. That is, on the basis of this control information, the data receiving apparatus selects key information used for the binary determination of the multilevel signal.

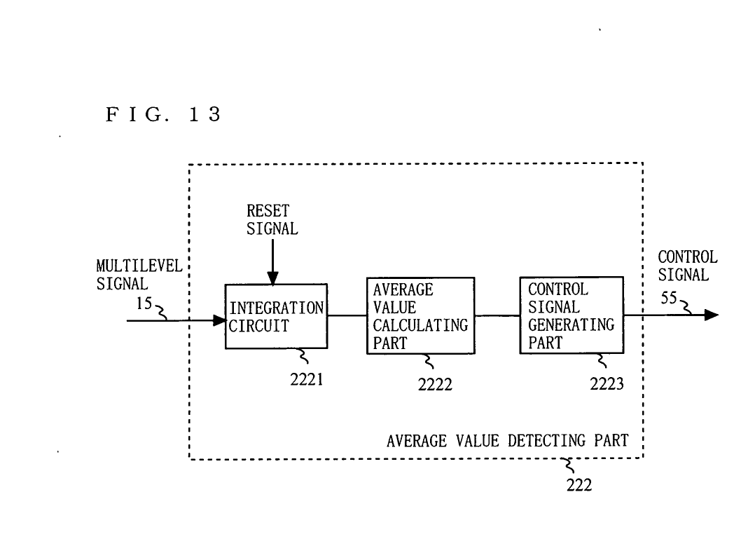

FIG. 12 is a block diagram showing an example of a configuration of a data communication system according to a sixth embodiment of the present invention. In FIG. 12, the data receiving apparatus 17206 according to the sixth embodiment further comprises an average value detecting part 222 in addition to the configuration of the data receiving apparatus 17205 (FIG. 8) according to the fifth embodiment. Further, the multilevel decoding part 212 further includes a second key information switching part 212c. The data communication system of the present embodiment is described below with focusing attention on the difference from the fifth embodiment. Here, the configuration of the present embodiment is similar to that of the fifth embodiment (FIG. 8). Thus, blocks that perform the same operation as the fifth embodiment are designated by the same reference numerals, and their description is omitted.

In the data receiving apparatus 17206, a light modulated signal 46 is inputted to the light demodulating part 219 via the optical transmission path 126. The light demodulating part 219 converts the inputted light modulated signal 46 into a multilevel signal 15. The multilevel signal 15 is inputted to the decision part 212b and the average value detecting part 222. The average value detecting part 222 calculates the average value of the multilevel signal 15 within a predetermined time, and outputs to the second key information switching part 212c a control signal 55 corresponding to the average value. On the basis of the control signal 55, the second key information switching part 212c selects key information necessary for the binary determination of the multilevel signal 15. The selected key information is inputted to the second multilevel code generating part 212b. The second multilevel code generating part 212b generates a multilevel code sequence 17 on the basis of the inputted key information. The multilevel code sequence 17 is inputted to the decision part 212b. Using the multilevel code sequence 17, the decision part 212b performs binary determination on the multilevel signal 15 and regenerates the information data 18.

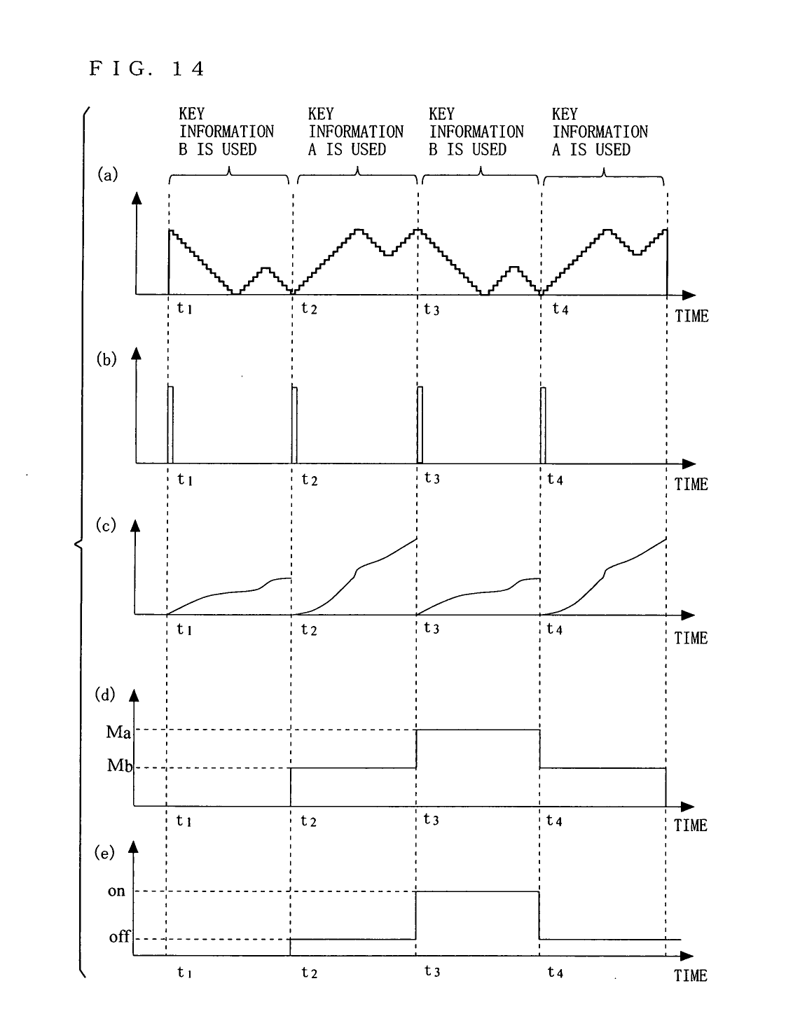

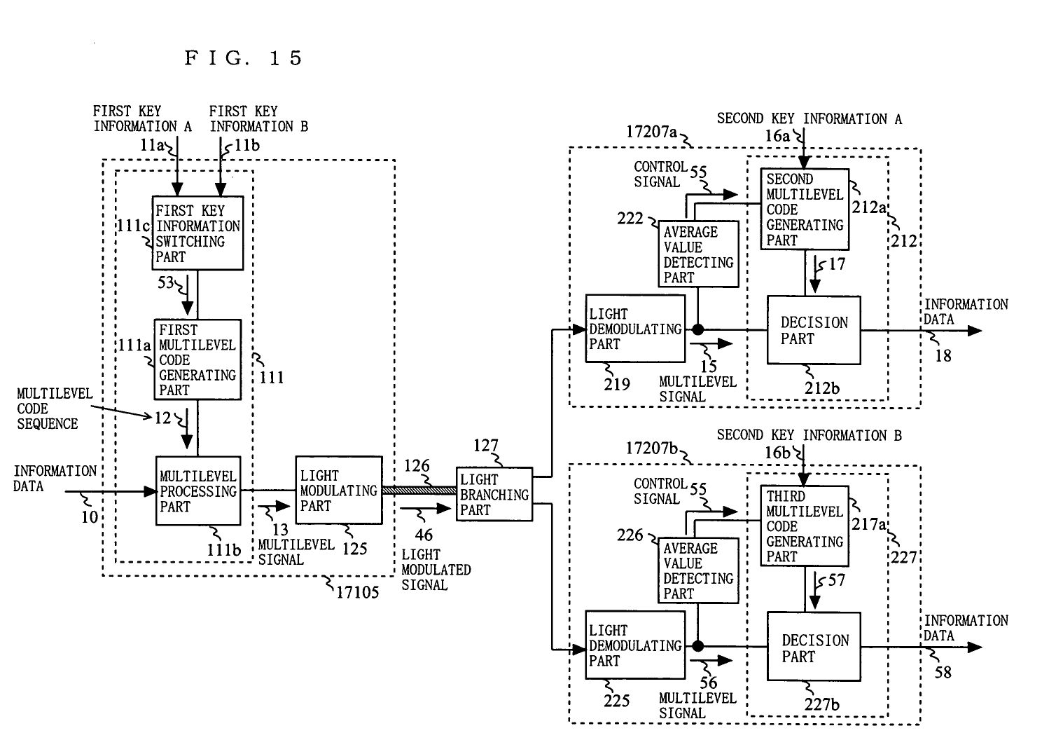

Details of the average value detecting part 222 are bond with reference to FIGS. 13 and 14. FIG. 13 is a block diagram showing an example of a configuration of an average value detecting part 222. In FIG. 13, the average value detecting part 222 has an integration circuit 2221, an average value calculating part 2222, and a control signal generating part 2223. FIG. 14(a) is a diagram showing a time-dependent change in the key information used in generating of the multilevel signal 15. As shown in FIG. 14(a), at time t1 tot2, the key information B is used for generating the multilevel signal 15. Further, at time t2 to t3, the key information A is used for generating the multilevel signal 15. Furthermore, at time t3 and after, the key information B and the key information A are alternately used for generating the multilevel signal 15.

FIG. 14(b) is a diagram showing an example of timing that a reset signal is inputted to the integration circuit 2221. As shown in FIG. 14(b), a reset signal is inputted to the integration circuit 2221 at predetermined time intervals. The integration circuit 2221 integrates the level of the multilevel signal 15 until the reset signal is inputted. When the reset signal is inputted, the integration circuit 2221 outputs the integration value to the average value calculating part 2222, and starts the integration of the level of the multilevel signal 15 again from 0. FIG. 14(c) shows the integration waveform of the integration circuit 2221.

The average value calculating part 2222 calculates the average value of the levels of the multilevel signal 15 from the integration value inputted from the integration circuit 2221, and outputs the calculated average value to the control signal generating part 2223. FIG. 14(d) shows the time-dependent change in the average value of the levels of the multilevel signal 15. As shown in FIG. 14(d), the average value calculating part 2222 outputs an average value Mb of the multilevel signal generated on the basis of the key information B at time t2.

When the average value of the multilevel signal 15 varies, the control signal generating part 2223 determines the key information used in generating of the multilevel signal 15. When the average value of the levels of the multilevel signal 15 falls within a predetermined value range, the control signal generating part 2223 determines that the multilevel signal 15 has been generated on the basis of the key information A. When outside the predetermined value range, it is determined that the multilevel signal 15 has been generated on the basis of the key information B.

A detailed example of operation of the control signal generating part 2223 is described below with reference to FIG. 14. For example, at time t2, an average value Mb is inputted from the average value calculating part 2222 to the control signal generating part 2223 (see FIG. 14(d)). On the basis of the inputted average value Mb, the control signal generating part 2223 determines that key information (referred to as “regeneration key information”, hereinafter) for regenerating the information data 18 at time t1 to t2 is the key information B. Then, the control signal generating part 2223 outputs the control signal 55 in an off state to the second key information switching part 212c (see FIG. 14(e)). When the control signal 55 is off, the second key information switching part 212c outputs the second key information B16b to the second multilevel code generating part 212b.

Further, at time t3, an average value Ma is inputted from the average value calculating part 2222 to the control signal generating part 2223 (see FIG. 14(d)). On the basis of the inputted average value Ma, the control signal generating part 2223 determines that the regeneration key information at time t2 to t3 is the key information A. Then, the control signal generating part 2223 outputs the control signal 55 in an on state to the key information switching part 212c (see FIG. 14(e)). When the control signal 55 is on, the second key information switching part 212c outputs the second key information A16a to the second multilevel code generating part 212b.

Here, in place of the above-mentioned determination method, for example, the control signal generating part 2223 may hold in advance the average value of the levels of the multilevel signal appearing in correspondence to each of the plurality of key information, and may determine the regeneration key information from the plurality of key information by using the average value held in advance and the average value calculated by the average value calculating part 2222. A detailed example of operation of the control signal generating part 2223 in this case is described below. First, the control signal generating part 2223 calculates the difference between the average value of the levels of the multilevel signal 15 and the average value held in advance, and determines that the key information corresponding to the case that the absolute value of the calculated difference becomes the minimum is the regeneration key information. In response to the determination result, the control signal generating part 2223 generates a control signal 55 for uniquely identifying the regeneration key information, and outputs it to the second key information switching part 212c. Here, when three or more pieces of key information need be presented, the control signal 55 is a signal that can take the levels of the number corresponding to the number of key information, in place of the on/off signal described above. Further, in place of the average value of the levels of the multilevel signal, the control signal generating part 2223 may hold in advance the average bias level of the multilevel code sequence that appears in correspondence to each of the plurality of key information.

On the basis of the control signal 55 outputted from the control signal generating part 2223, the second key information switching part 212c switches the key information outputted to the multilevel code generating part 212b. Thus, using the average value of the levels of the received multilevel signal, the data receiving apparatus 16106 determines the key information used in encoding of the multilevel signal, and performs binary determination of the received multilevel signal.

As described above, according to the data communication system of the present embodiment, the data transmitting apparatus 17105 switches a plurality of key information at predetermined time intervals, and thereby generates a multilevel signal in which the average values of signal levels are different in respective key information. On the basis of the average value of the levels of the received multilevel signal, the data receiving apparatus 17206 determines the key information used for deciding the logic of the information data from the plurality of key information. Thus, even when the timing of switching the key information is not synchronized in the data transmitting apparatus 17105 and the data receiving apparatus 17206, the data communication system according to the present embodiment can perform data communication with higher concealment in comparison with the data communication system according to the first embodiment.

Here, in the description of FIG. 14, the timing of transmission of the reset signal has been in agreement with the timing of switching of the key information. However, the timing of transmission of the reset signal may be shorter than the interval of switching the key information. In the method of FIG. 14, the average value detecting part 222 calculates the average value of the multilevel signal 15 at the timing of switching of the key information, and determines the key information used in generating of the multilevel signal 15. At time t1 to t2, the average value detecting part 222 determines the key information at time after the time t2. Thus, the decision part 212b performs binary determination of the multilevel signal 15 after the time t2. This causes a time delay t2−t1 in regeneration of the information data 18. When the timing of transmission of the reset signal is set to be shorter than the switching interval of the key information, the delay in the binary determination of the multilevel signal can be reduced.

Further, the sequence of key information to be used may be defined in advance. In this case, the average value detecting part 222 may transmit information concerning the key information to be used in the next of the determined key information, as the control signal 55 to the second key information switching part 212c. Then, the delay in the binary determination of the multilevel signal can be reduced in comparison with the case that the control information concerning the determined key information is outputted to the second key information switching part 212c. Further, this can address also the situation that the average detection needs a long time. Further, the second multilevel code generating part 212b may store the sequence of changing the key information and the key information, so that the second key information switching part 212c may be omitted.

Further, FIG. 13 shows an example of a configuration of the average value detecting part 222. As such, the average value detecting part 222 may have another configuration as long as it realizes the function of the average value detecting part 222 described in FIGS. 13 and 14.

### Seventh Embodiment

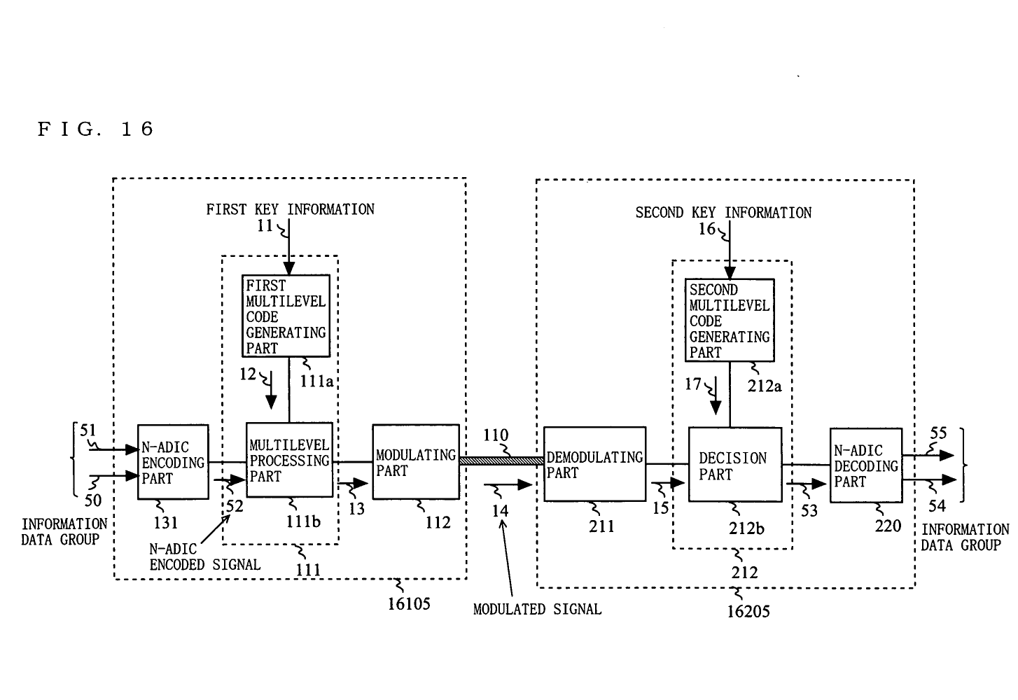

FIG. 15 is a block diagram showing a configuration of a data communication system according to a seventh embodiment of the present invention. In FIG. 15, the data communication system according to the seventh embodiment has a configuration that a data transmitting apparatus 17105, a first data receiving apparatus 17207a and a second data receiving apparatus 17207b are connected via an optical transmission path 126 and a branching part 127. The first data receiving apparatus 17207a includes a light demodulating part 219, a decision part 212 and an average value detecting part 222. The decision part 212 includes a second multilevel code generating part 212a and a decision part 212b. The second data receiving apparatus 17207b includes a light demodulating part 225, an average value detecting part 226 and a decision part 227. The decision part 227 includes a second multilevel code generating part 227a and a decision part 227b.

As seen from FIG. 15, the first data receiving apparatus 17207a and the second data receiving apparatus 17207b have the same configuration. Further, in the first data receiving apparatus 17207a and the second data receiving apparatus 17207b, the multilevel decoding part 212 is different from the multilevel decoding part 212 (FIG. 12) of the sixth embodiment in the point that the second key information switching part is not included. The data communication system according to the seventh embodiment is described below with focusing attention on this difference. Here, the configuration of the present embodiment is similar to that of the sixth embodiment (FIG. 12). Thus, blocks that perform the same operation are designated by the same reference numerals, and their description is omitted.

The multilevel encoding part 111 switches the first key information A11a and the first key information B11b at predetermined time intervals, and generates a multilevel signal 13 using the switched key information and the information data 10. The light modulating part 125 modulates the multilevel signal 13 into a light modulated signal 46, and transmits it to the optical transmission path 126. The light branching part 127 branches the light modulated signal 46 into two. The light modulated signals 46 branched by the light branching part 127 are inputted to the first data receiving apparatus 17207a and the second data receiving apparatus 17207b.

Further, the second key information A16a is inputted to the first data receiving apparatus 17207a. Thus, the first data receiving apparatus 17207a can perform binary determination only for a multilevel signal corresponding to the second key information A16a. Further, the second key information B16b is inputted to the second data receiving apparatus 17207b. Thus, the second data receiving apparatus 17207b can perform binary determination only for a multilevel signal generated on the basis of the second key information B16b. Details of operation of each data receiving apparatus are described below.

The first data receiving apparatus 17207a demodulates the light modulated signal 46 into the multilevel signal 13. The average value detecting part 222 detects the average value of the levels of the multilevel signal 15. When detecting the average value of the levels of a multilevel signal corresponding to the second key information A, the average value detecting part 222 outputs a control signal to the second multilevel code generating part 212b. The second multilevel code generating part 212a outputs the multilevel code sequence 17 to the decision part 212b only during the time that the average value detecting part 222 outputs the control signal. When the multilevel code sequence 17 is inputted, the decision part 212b performs binary determination of the multilevel signal 15. As such, the first data receiving apparatus 17207a can perform binary determination of a multilevel signal processed by multilevel processing with the corresponding key information.

The second data receiving apparatus 17207b performs operation similar to that of the first data receiving apparatus 17207a. Here, the second key information B16b is inputted to the second data receiving apparatus 17207b. Thus, the average value detecting part 226 provided in the second data receiving apparatus 17207b detects the average value of the levels of the multilevel signal 15 corresponding to the second key information B16b.

As described above, according to the data communication system of the present embodiment, the data transmitting apparatus 17105 switches a plurality of key information at predetermined time intervals, thereby generates a multilevel signal in which the average values of signal levels are different in respective key information, and transmits the generated multilevel signal to a plurality of data receiving apparatuses 17207a to 17207b. The data receiving apparatuses 17207a to 17207b decode the multilevel signal on the basis of the inputted key information only when the average value of the levels of the multilevel signal generated on the basis of the inputted key information agrees with the average value of the levels of the received multilevel signal. Thus, in the data communication system of the present invention, the data transmitting apparatus 17105 can transmit encrypted data to the plurality of data receiving apparatuses 17207a to 17207b.

Here, the present embodiment has been described for the case that two kinds of key information are used in the data communication system. However, the key information to be used is not limited to the two kinds. That is, the data communication system may use three or more kinds of key information. Further, the data communication system may define in advance the sequence of key information to be switched. Then, when detecting an average value corresponding to the key information that precedes the regeneration key information, the average value detecting part 222 may output a control signal 55 for uniquely identifying the regeneration key information. By virtue of this, even when the detection of the average value of the multilevel signal needs a long processing time, the data communication system can decode the multilevel signal.

### Eighth Embodiment

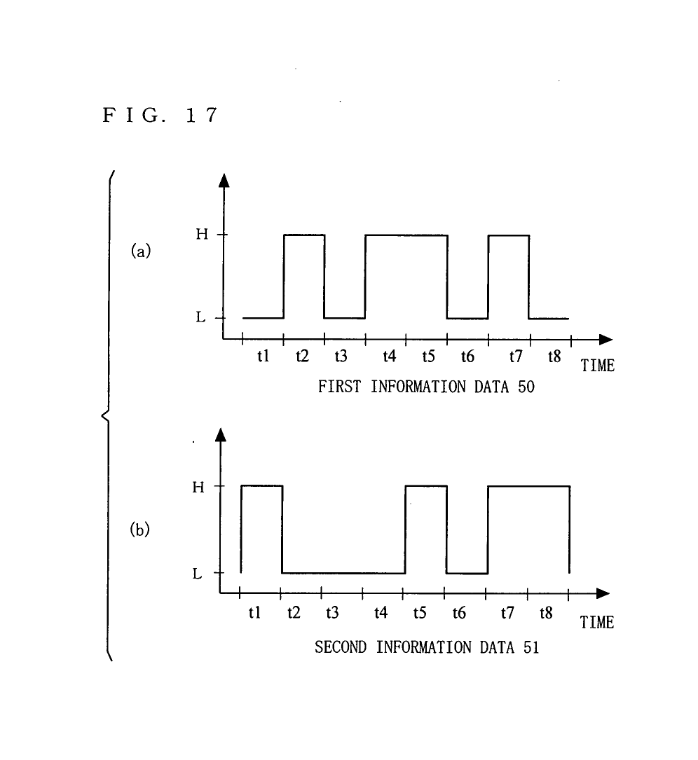

FIG. 16 is a block diagram showing a configuration of a data communication system according to an eighth embodiment of the present invention. In FIG. 16, the data communication system according to the eighth embodiment is different from the data communication system (FIG. 1) according to the first embodiment in the point that the data transmitting apparatus 16105 further comprises an N-adic encoding part 131 and that the data receiving apparatus 16205 further comprises an N-adic decoding part 220.

The data communication system according to the tenth embodiment is described below with focusing attention on the N-adic encoding part 131 and the N-adic decoding part 220. Here, the configuration of the present embodiment is similar to that of the first embodiment (FIG. 1). Thus, blocks that perform the same operation are designated by the same reference numerals, and their description is omitted.

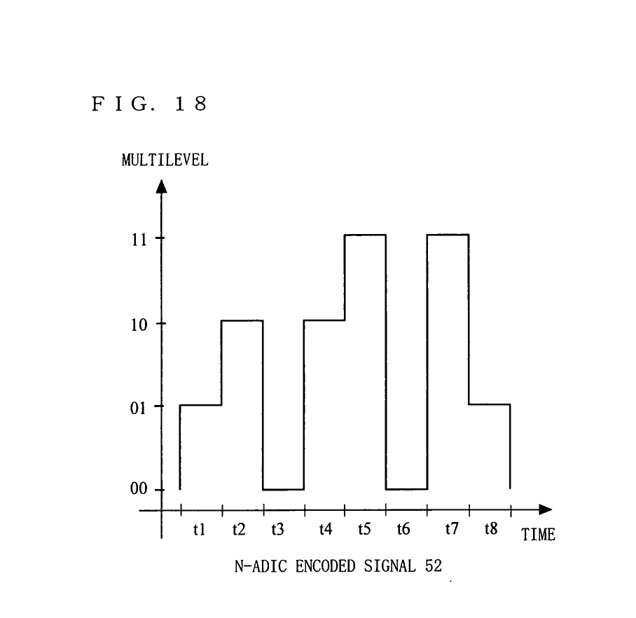

In the data transmitting apparatus 16105, an information data group composed of a plurality of information data is inputted to the N-adic encoding part 131. Here, as the information data group, first information data 50 and second information data 51 are inputted. FIG. 17 is a diagram showing an exemplary waveform of an information data group inputted to an N-adic encoding part 131. FIG. 17(a) shows the first information data 50 inputted to the N-adic encoding part 131. FIG. 17(b) shows the second information data 51 inputted to the N-adic encoding part 131.

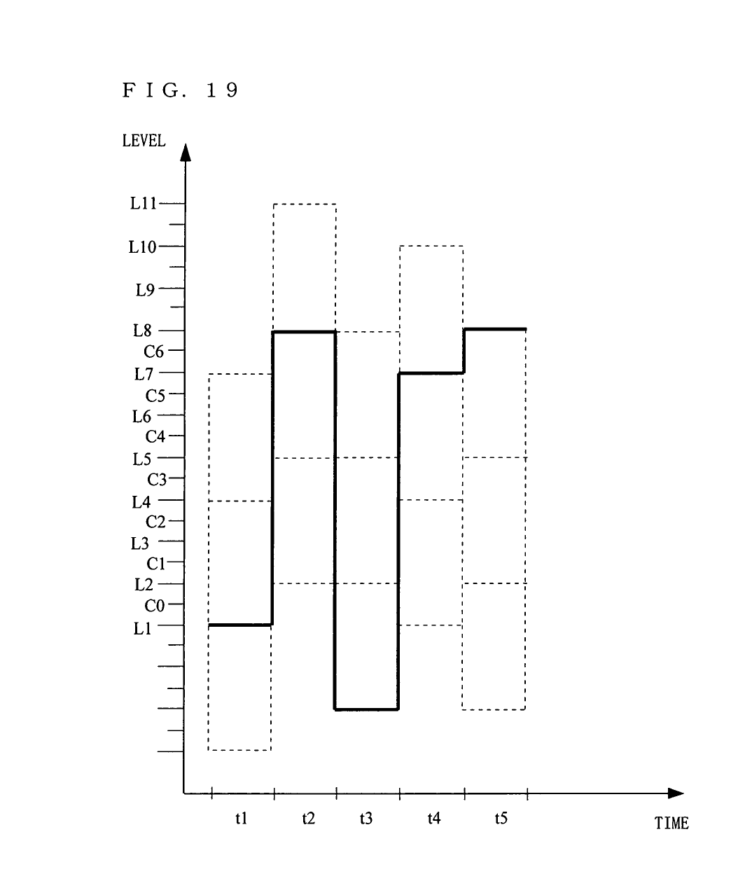

The N-adic encoding part 131 encodes the first information data 50 and the second information data 51 into an N-adic number (N=4 in this example), and outputs it as an N-adic encoded signal 52 having predetermined multi valued levels. Here, N is an arbitrary natural number. Thus, the N-adic encoding part 131 can increase by a factor of log₂ N the information amount transmittable per one time slot. FIG. 18 is a diagram showing an exemplary waveform of an N-adic encoded signal 52 outputted from an N-adic encoding part 131. Referring to FIG. 18, for example, the N-adic encoding part 131 assigns a multi valued level 00 when the combination of logic in the first information data 50 and the second information data 51 is {L,L}. Further, a multi valued level 01 is assigned in the case of {L,H}, a multi valued level 10 is assigned in the case of {H,L}, and a multi valued level 11 is assigned in the case of {H,H}. As such, an N-adic encoded signal 52 having four multi valued levels can be outputted. The N-adic encoded signal 52 outputted from the N-adic encoding part 131 and the multilevel code sequence 12 (see FIG. 2(b)) outputted from the first multilevel code generating part 111a are inputted to the multilevel processing part 111b.

The multilevel processing part 111b combines the N-adic encoded signal 52 and the multilevel code sequence 12 in accordance with a predetermined procedure, and outputs the compound signal as a multilevel signal 13. For example, the multilevel processing part 111b adopts the level of the multilevel code sequence 12 as a bias level, and adds the N-adic encoded signal 52 so as to generate the multilevel signal 13. Alternatively, the multilevel processing part 111b may perform amplitude modulation on the multilevel code sequence 12 with the N-adic encoded signal 52 so as to generate the multi level signal 13. FIG. 19 shows an exemplary waveform of a multilevel signal 13 outputted from the multilevel processing part 111b. In FIG. 19, the multi valued level of the multilevel signal 13 varies at four steps at a predetermined level interval (a three-level interval in this example). Here, the dotted line indicates a range within which the multi valued level of the multilevel signal 13 varies with reference to the bias level (multilevel code sequence 12).

The multilevel signal 13 outputted from the multilevel processing part 111b is inputted to the modulating part 112. The modulating part 112 modulates the multilevel signal 13 into a signal form appropriate for the transmission path 110, and transmits the modulated signal as a modulated signal 14 to the transmission path 110. For example, when the transmission path 110 is an optical transmission path, the modulating part 12 modulates the multilevel signal 13 into an optical signal.

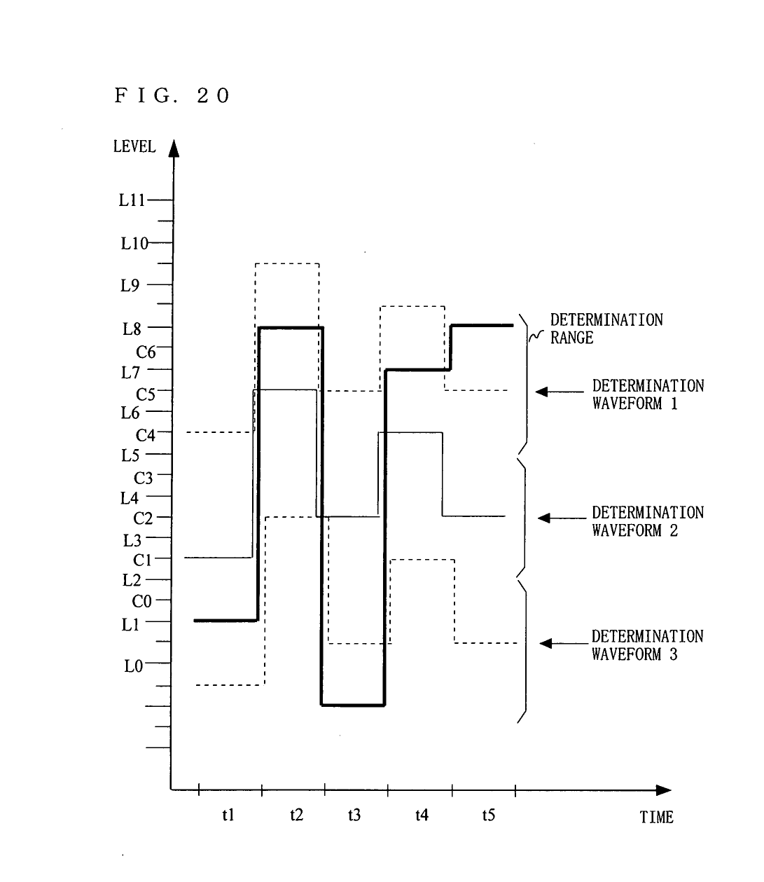

In the data receiving apparatus 16205, the demodulating part 211 receives the modulated signal 14 via the transmission path 110. The demodulating part 211 demodulates the modulated signal 14 and outputs a multilevel signal 15. The multilevel signal 15 is inputted to the decision part 212b. The decision part 212b receives the multilevel signal 15, and decides an N-adic encoded signal 53 by using the multilevel code sequence 17 outputted from the second multilevel code generating part 212a, and outputs the N-adic encoded signal 53. FIG. 20 is a diagram describing an example of decision operation in the decision part 212b. In FIG. 20, the thick solid line indicates the waveform of the multilevel signal 15. The thin solid line and the dotted line indicate the determination waveforms for deciding the N-adic encoded signal 53. Here, the thin solid line (determination waveform 2) indicates the waveform of the multilevel code sequence 17.

Referring to FIG. 20, the decision part 212b generates: a waveform (determination waveform 1) in which the multilevel code sequence 17 is shifted upward by a predetermined level interval with adopting the multilevel code sequence 17 (determination waveform 2) as the center; and a waveform (determination waveform 3) shifted downward by a predetermined level interval. Here, this predetermined level interval is defined in advance in relation to the multilevel processing part 111b in the data transmitting apparatus 16105, and is a three-level interval in this example. Then, the decision part 212b receives the multilevel signal 15, and decides the N-adc encoded signal 53 by using the determination waveforms 1 to 3.

In the time slot t1, the decision part 212b compares the multilevel signal 15 with the determination waveform 1, and determines that the multilevel signal 15 is at Low level relative to the determination waveform 1. Further, the multilevel signal 15 is compared with the determination waveform 2, so that it is determined that the multilevel signal 15 is at Low level relative to the determination waveform 2. Further, the multilevel signal 15 is compared with the determination waveform 3, so that it is determined that the multilevel signal 15 is at High level relative to the determination waveform 3. That is, in the time slot t1, the decision part 212b determines that the multilevel signal 15 is {Low, Low, High}. Similarly, the decision part 212b determines that the multilevel signal 15 is {Low, High, High} in the time slot t2, and that the multilevel signal 15 is {Low, Low, Low} in the time slot t3. The operation in the time slot t4 and after is omitted but similar.

Then, the decision part 212b establishes correspondence of the number of determined Lows and Highs to the multi valued level of the N-adic encoded signal 52, and thereby regenerates the N-adic encoded signal 52. For example, the decision part 212b establishes correspondence of {Low, Low, Low} to the multi valued level 00, {Low, Low, High} to the multi valued level 01, {Low, High, High} to the multi valued level 10, and {High, High, High} to the multi valued level 11, so that the N-adic encoded signal 53 can be regenerated. The N-adic encoded signal 53 regenerated by the decision part 212b is inputted to the N-adic decoding part 220.

The N-adic decoding part 220 decodes the N-adic encoded signal 52 and outputs it as an information data group. Specifically, the N-adic decoding part 220 performs inverse operation of that of the N-adic encoding part 131, and thereby outputs the first information data 54 and the second information data 55 from the N-adic encoded signal 52.

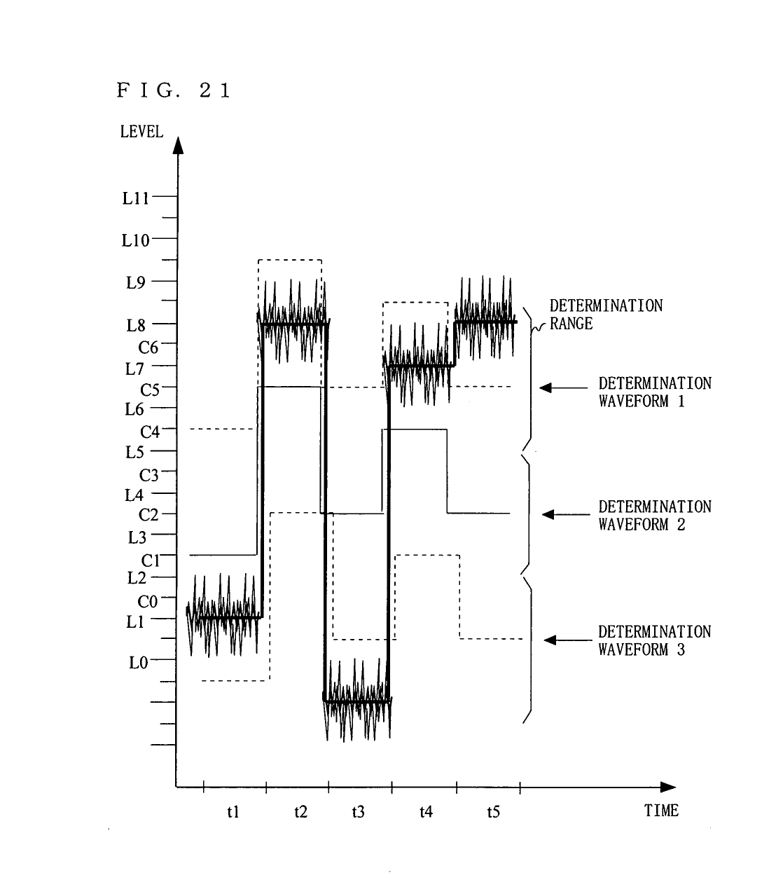

Wiretapping operation for the modulated signal 14 by a third person is described next. Similarly to the case described in the first embodiment, a third person does not share the first key information 11 with the data transmitting apparatus 16105, and hence cannot regenerate the first information data 54 and the second information data 55 from the wiretapped modulated signal 14. Further, in the actual transmission system, noise occurs owing to various factors. Then, this noise is superimposed on the modulated signal 14. That is, noise is superimposed also on the multilevel signal 15 demodulated from the modulated signal 14. FIG. 21 is a diagram showing a waveform of a multilevel signal 15 onto which noise is superimposed. Referring to FIG. 21, similarly to the case described in the first embodiment, by virtue of the noise superimposed on the multilevel signal 15, the data communication system according to the eighth embodiment can induce identification errors in the brute force attack using all thresholds by the third person, and thereby cause further difficulty in the wiretapping.

As described above, according to the present embodiment, the N-adic encoding part 131 converts collectively the information data group into the N-adic encoded signal 52, while the N-adic decoding part 220 regenerates collectively the information data group from the N-adic encoded signal 53. Thus, in comparison with the data communication system according to the first embodiment, the data communication system according to the present embodiment can increase the information amount transmittable per one time slot. Further, the conversion of the information data group into the N-adic encoded signal 52 realizes data transmission of high concealment.

### Ninth Embodiment

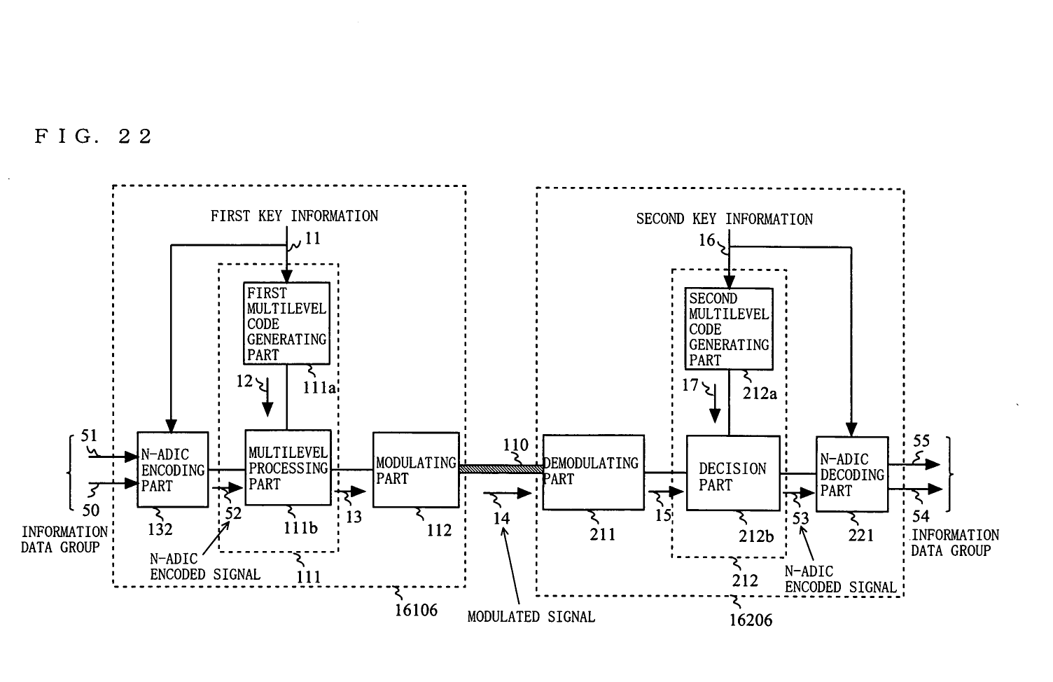

FIG. 22 is a block diagram showing an exemplary configuration of a data communication system according to a ninth embodiment of the present invention. In FIG. 22, in the data communication system according to the ninth embodiment, the operation of the N-adic encoding part 132 and the N-adic decoding part 221 is different from the eighth embodiment (FIG. 16). In the ninth embodiment, the N-adic encoding part 132 generates an N-adic encoded signal 52 from the information data group on the basis of the first key information 11. Further, the N-adic decoding part 221 generates an information data group from the N-adic encoded signal 53 on the basis of the second key information 16. The data communication system according to the ninth embodiment is described with focusing attention on the N-adic encoding part 132 and the N-adic decoding part 221. Here, the configuration of the present embodiment is similar to that of the eighth embodiment (FIG. 16). Thus, blocks that perform the same operation are designated by the same reference numerals, and their description is omitted.

In the data transmitting apparatus 16106, first key information 11 is inputted to the N-adic encoding part 132. The N-adic encoding part 132 generates an N-adic encoded signal 52 from the information data group on the basis of the first key information 11. For example, on the basis of the first key information 11, the N-adic encoding part 132 changes the correspondence relation between the combination of logic in the first information data 50 and the second information data 51 and the multi valued level of the N-adic encoded signal 52. The N-adic encoded signal 52 outputted from the N-adic encoding part 132 is inputted to the multilevel processing part 111b.

In the data receiving apparatus 16206, the N-adic encoded signal 53 outputted from the decision part 212b is inputted to the N-adic decoding part 221. Further, the second key information 16 is inputted to the N-adic decoding part 221. On the basis of the second key information 16, the N-adic decoding part 221 outputs the information data group from the N-adic encoded signal 53. Specifically, the N-adic decoding part 221 performs inverse operation of that of the N-adic encoding part 132, and thereby outputs the first information data 54 and the second information data 55 from the N-adic encoded signal 53.

As described above, according to the present embodiment, on the basis of the first key information 11, the N-adic encoding part 132 generates an N-adic encoded signal 52 from the information data group, while on the basis of the second key information 16, the N-adic decoding part 221 regenerates the information data group from the N-adic encoded signal 53 by the inverse operation of that of the N-adic encoding part 132. Thus, in comparison with the data communication system according to the eighth embodiment, the data communication system according to the present embodiment realizes data communication in which wiretapping is more difficult.

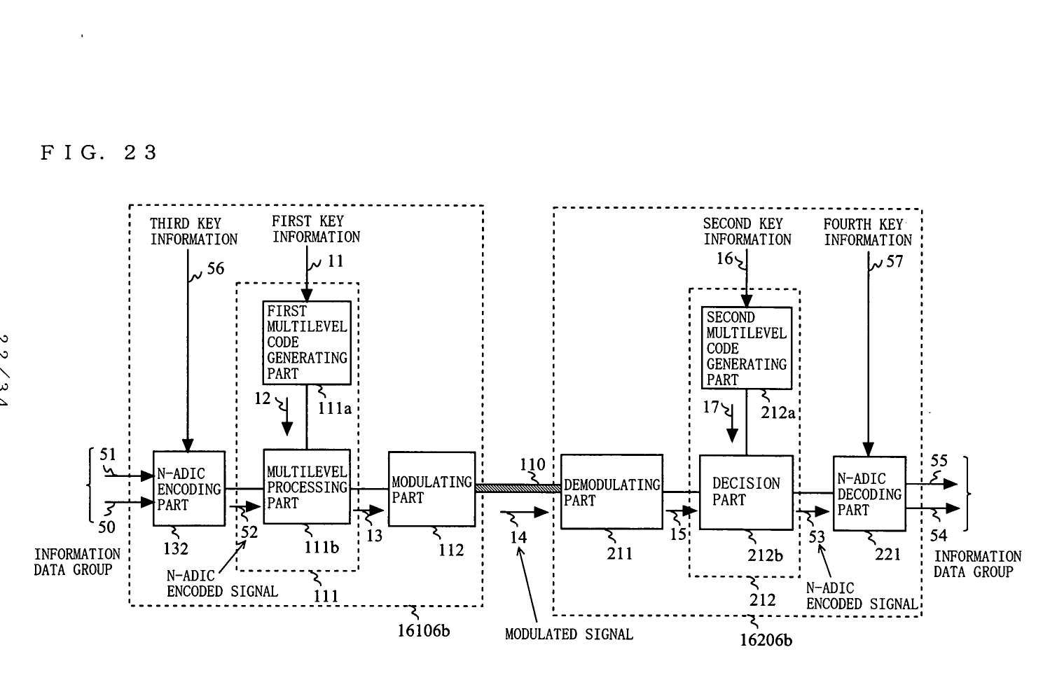

Here, in the data communication system according to the ninth embodiment, the N-adic encoding part 132 may generate the N-adic encoded signal 52 from the information data group by using third key information 56 different from the first key information 11. Similarly, the N-adic decoding part 221 may regenerate the information data group from the N-adic encoded signal 53 by using fourth key information 57 different from the second key information 16 (see FIG. 23). Here, the third key information 56 and the fourth key information 57 are the same key information. By virtue of this, in the data communication system according to the present embodiment, the key information used in the multilevel processing part 111b can be separated from the key information used by the N-adic encoding part 132. This realizes data communication in which wiretapping is more difficult.

### Tenth Embodiment

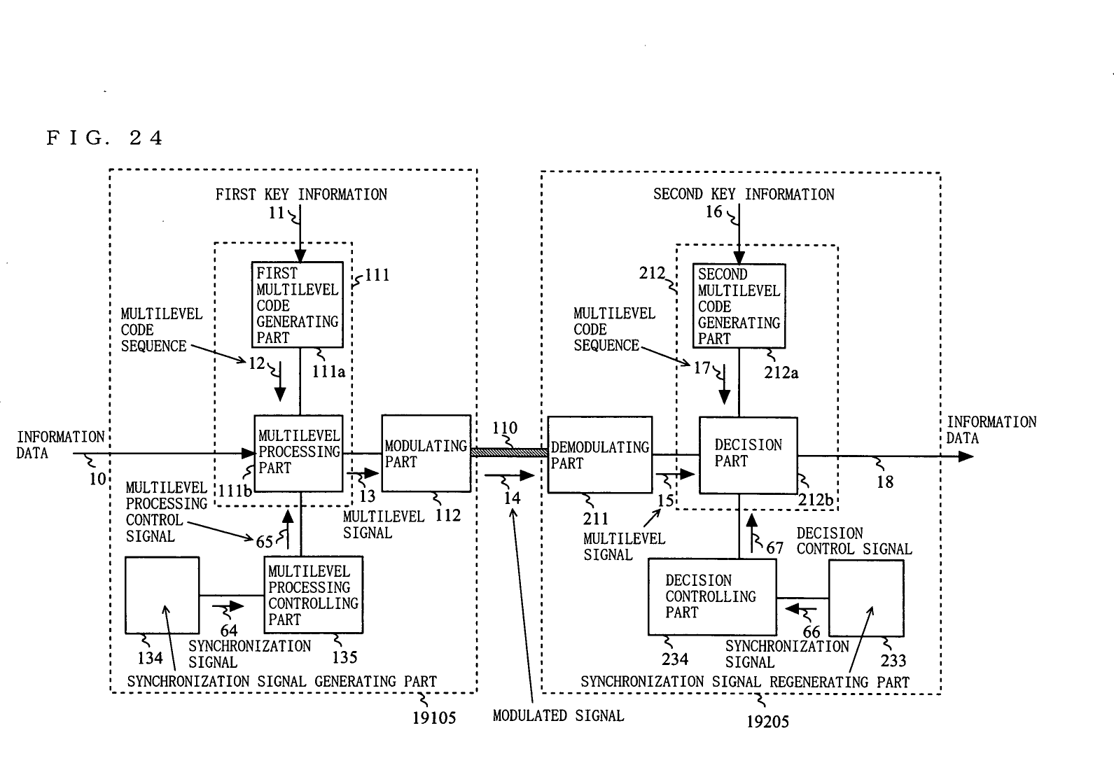

FIG. 24 is a block diagram showing a configuration of a data communication system according to a tenth embodiment of the present invention. In FIG. 24, the data communication system according to the tenth embodiment is different from the first embodiment (FIG. 1) in the point that the data transmitting apparatus 19105 further comprises a synchronization signal generating part 134 and a multilevel processing controlling part 135 and that the data receiving apparatus 19205 further comprises a synchronization signal regenerating part 233 and a decision controlling part 234.

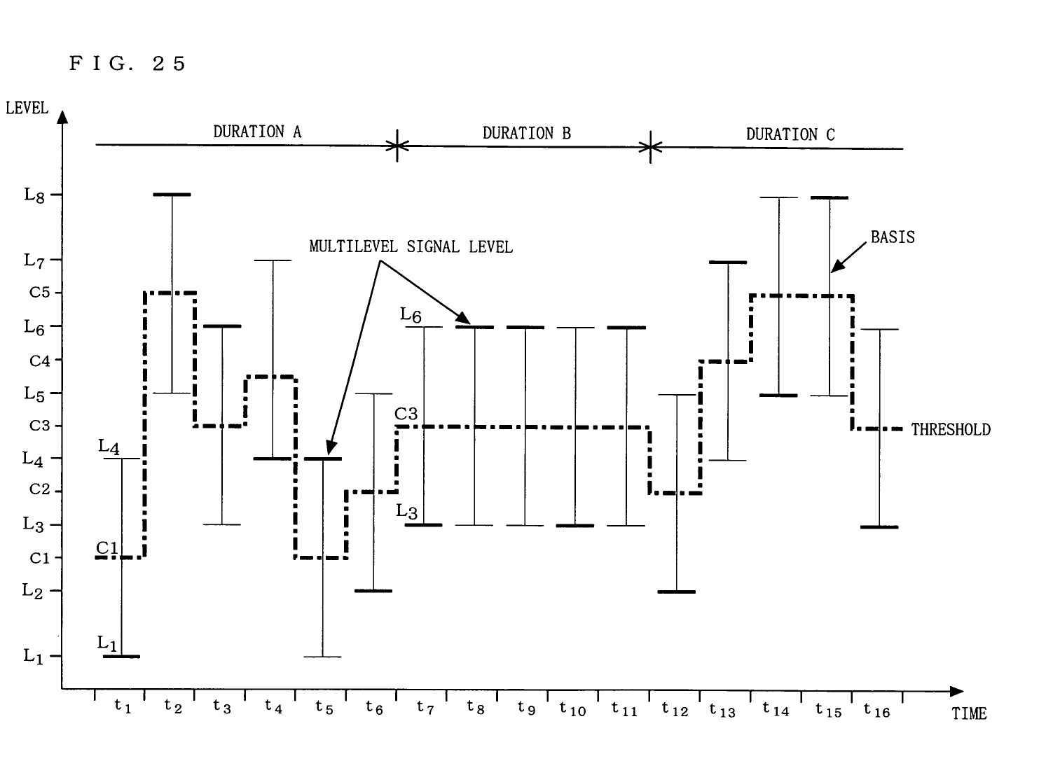

FIG. 25 is a schematic diagram describing a signal waveform outputted from the multilevel encoding part 111. The data communication system according to the tenth embodiment is described below with reference to FIGS. 24 and 25. Here, the configuration of the present embodiment is similar to that of the first embodiment (FIG. 1). Thus, blocks that perform the same operation are designated by the same reference numerals, and their description is omitted.

In FIG. 24, the synchronization signal generating part 134 generates a synchronization signal 64 of a predetermined period, and outputs it to the multilevel processing controlling part 135. The multilevel processing controlling part 135 generates a multilevel processing control signal 65 on the basis of the synchronization signal 64, and outputs it to the multilevel processing part 111b. The multilevel processing control signal 65 is a signal that specifies the level number (referred to as a multi valued number, hereinafter) of the multilevel signal 13 outputted from the multilevel processing part 111b. On the basis of the multilevel processing control signal 65 and the multilevel code sequence 12, the multilevel processing part 111b generates a multilevel signal from the information data 10, and outputs as the multilevel signal 13 a signal in which the multi valued number of the generated multilevel signal is switched. For example, as shown in FIG. 25, the multilevel processing part 111b outputs a multilevel signal having a multi valued number of “8” in the durations A and C, and outputs a signal having a multi valued number of “2” in the duration B. More specifically, in the durations A and C, the multilevel processing part 111b may combine the information data 10 and the multilevel code sequence 12 and output it. In the duration B, the information data 10 may be outputted intact.

The synchronization signal regenerating part 233 regenerates the synchronization signal 66 corresponding to the synchronization signal 64, and outputs it to the decision controlling part 234. The decision controlling part 234 generates a decision control signal 67 on the basis of the synchronization signal 66, and outputs it to the decision part 212b. On the basis of the decision control signal 67, the decision part 212b switches the threshold (multilevel code sequence 17) for the multilevel signal 15 outputted from the demodulating part 211, and performs decision so as to regenerate the information data 18. For example, as shown in FIG. 58, as for a multilevel signal having a multi valued number of value “8” in the durations A and C, the decision part 212b decides as the threshold the multilevel code sequence 17 in which the level varies sequentially, and performs decision on the binary signal on the basis of a predetermined fixed threshold in the duration B.

Here, in FIG. 25, the threshold (average level) for the binary signal in the duration B is set up equal to the average level (C3) of the multilevel signal in the durations A and C. However, the present invention is not limited to this. That is, any level may be employed. Further, in FIG. 25, the amplitude of the binary signal in the duration B is set up equal to the amplitude (information amplitude) of the information data 10. However, the present invention is not limited to this. Any amplitude may be employed as long as it is a magnitude that can be decided with a fixed threshold in the decision part 212b. Further, in FIG. 25, the transfer rate of the multilevel signal is set to be the same in the durations A and C and in the duration B. However, the present invention is not limited to this. Different transfer rates may be employed. In particular, from the perspective of transmission efficiency, it is preferable that a higher transfer rate is employed when the multi valued number is smaller.

Further, in FIG. 25, the multilevel processing part 111b outputs the multilevel signal 13 in which a multi level signal having a multi valued number of 8 and a binary signal are switched. However, the combination of the multi valued numbers of the multilevel signal 13 is not limited to this. Any combination of the multi valued numbers may be employed. For example, the multilevel processing part 111b may switch and output a multilevel signal having a multi valued number of “8” and a multilevel signal having a multi valued number of “4”. Further, in response to the values of the multi valued numbers, the data communication system shown in FIG. 24 may change the transfer rate for the information data 10 and 18, the multilevel code sequences 12 and 17 and the multilevel signals 13 and 15.

As described above, according to the present embodiment, information data to be transmitted is encoded as a multilevel signal. Then, critical degradation is imparted to the received signal quality at the time of wiretapping by a third person, so that a security communication channel solely for a particular receiving person is ensured. At the same time, the multi valued number is reduced appropriately, so that communication not requiring security is realized selectively. By virtue of this, a concealed communication service and a general communication service can be provided in a mixed manner by using the same modulating and demodulating system and transmission system. This provides an efficient communication system.

### Eleventh Embodiment

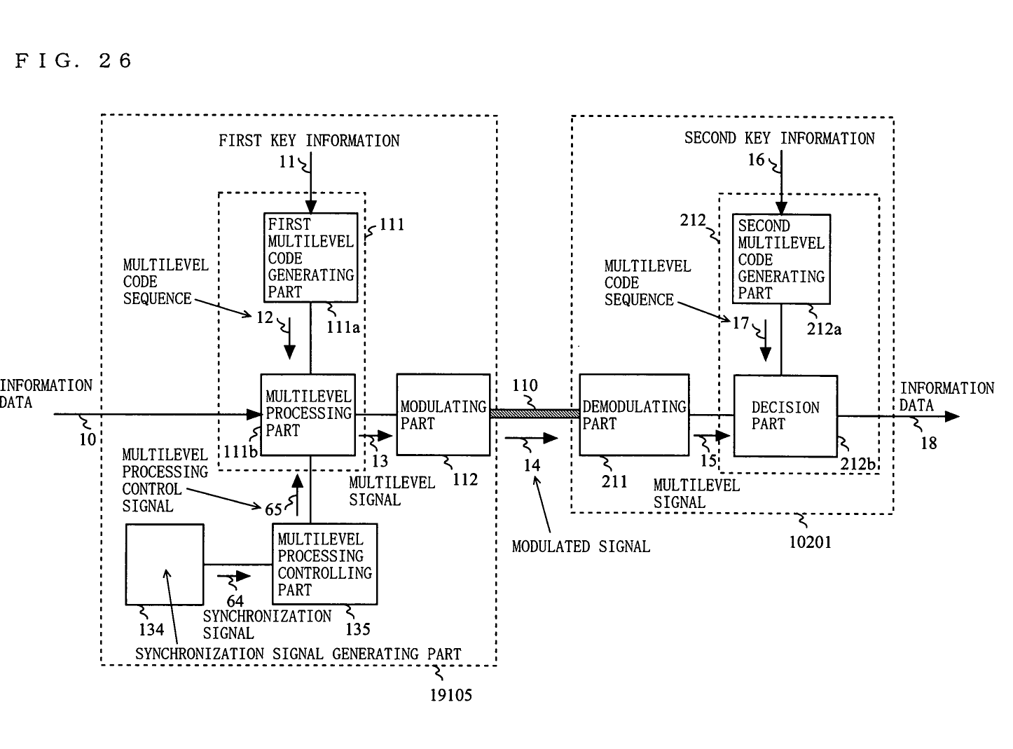

FIG. 26 is a block diagram showing a configuration of a data communication system according to an eleventh embodiment of the present invention. In FIG. 26, the data communication system according to the eleventh embodiment is different from the tenth embodiment (FIG. 24) in the point that the data receiving apparatus 10201 does not comprise the synchronization signal regenerating part 233 and the decision controlling part 234.

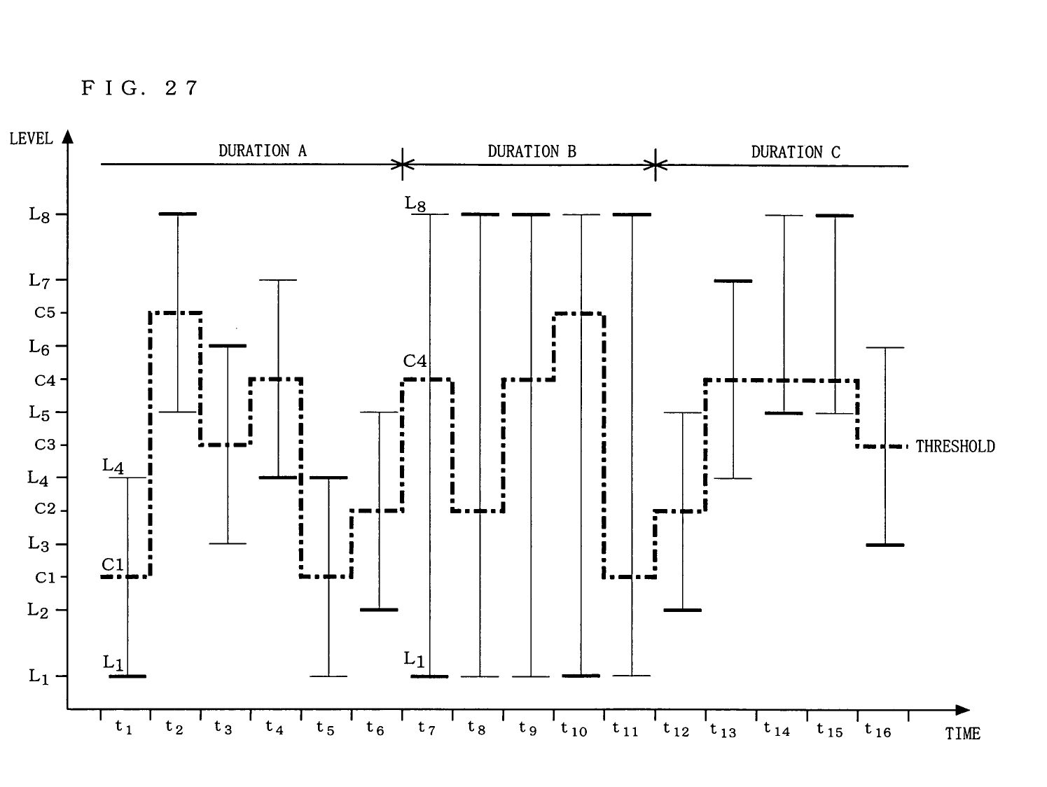

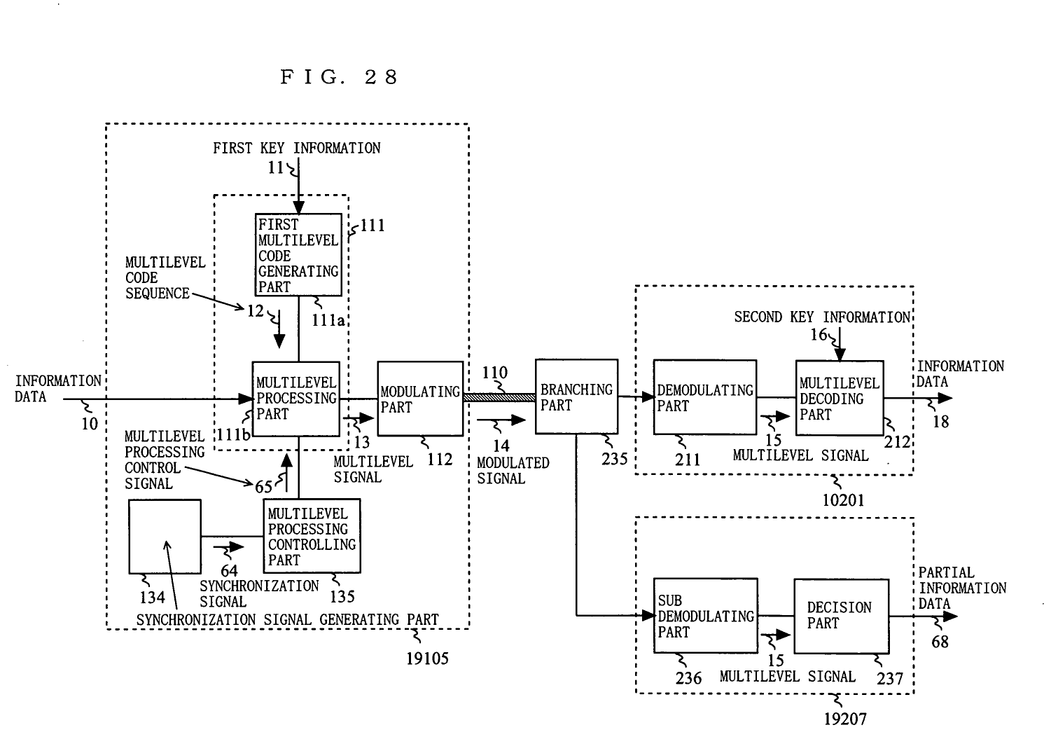

FIG. 27 is a schematic diagram describing a signal waveform outputted from the multilevel encoding part 111. The data communication system according to the eleventh embodiment is described below with reference to FIGS. 26 and 27. Here, the configuration of the present embodiment is similar to that of the tenth embodiment (FIG. 24). Thus, blocks that perform the same operation are designated by the same reference numerals, and their description is omitted.

In FIG. 26, on the basis of the multilevel processing control signal 65, the multilevel processing part 111b switches and outputs the multi valued number of the multilevel signal 13 which is the output signal, and sets up the multilevel signal amplitude to be larger when the multi valued number of the multi level signal 13 is reduced. For example, as shown in FIG. 27, in a case that the multi valued number is “8” in the durations A and C, a multi valued number “2” is used and the amplitude is increased in the duration B. More specifically, the binary signal amplitude in the duration B is set up equal to or greater than the multilevel signal amplitude in the durations A and C, and then the signal is outputted.

The decision part 212b receives the multilevel signal 15 outputted from the demodulating part 211, and decides the logic of the information data with adopting the multilevel code sequence 17 as the threshold regardless of the multi valued number, and regenerates the information data 18. For example, as shown in FIG. 27, as for the multilevel signal having a total level number of “8” in the durations A and C, identification is performed with adopting as the threshold the multilevel code sequence 17 in which the level varies sequentially, while identification is performed on the binary signal on the basis of the multilevel code sequence 17 also in the duration B.

As described above, according to the present embodiment, information data to be transmitted is encoded as a multilevel signal, and critical degradation is imparted to the received signal quality at the time of wiretapping by a third person, so that a security communication channel is ensured solely for a particular receiving person. Further, the multi valued number is reduced appropriately while the amplitude is increased, so that simple threshold control is achieved at the time of multi level signal receiving. This allows a simpler configuration to selectively realize communication not requiring security. By virtue of this, a concealed communication service and a general communication service can be provided in a mixed manner by using the same modulating and demodulating system and transmission system. This provides an efficient and economic communication system.

### Twelfth Embodiment

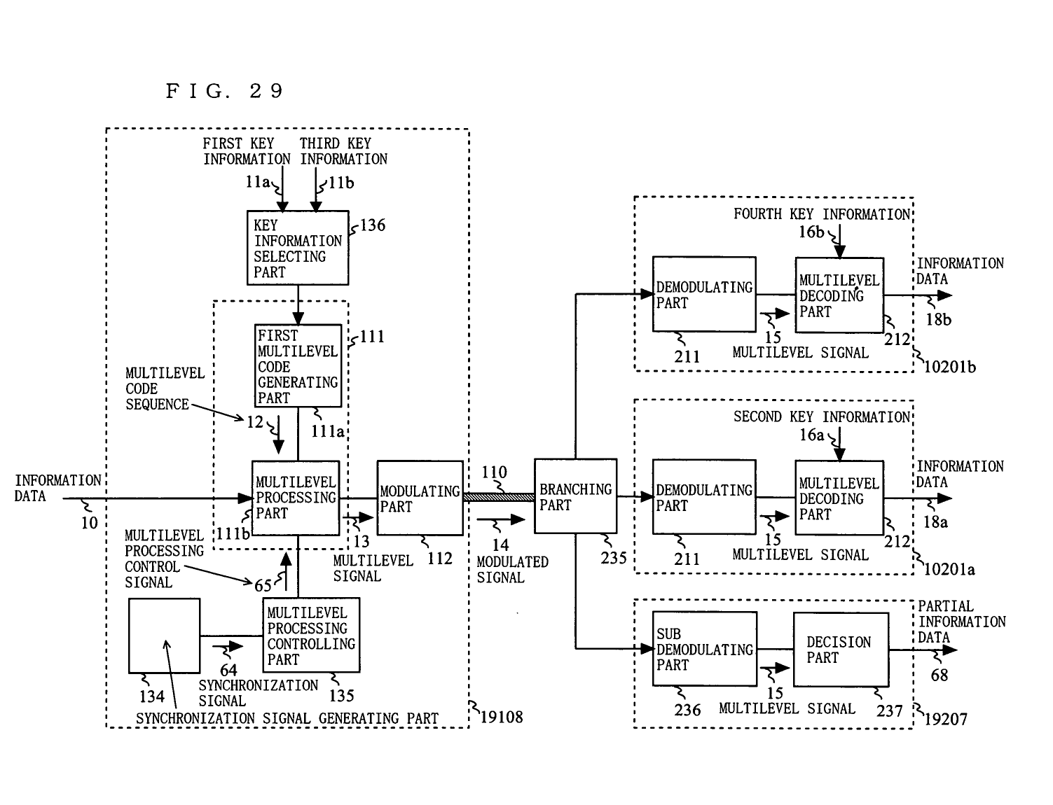

FIG. 28 is a block diagram showing a configuration of a data communication system according to a twelfth embodiment of the present invention. In FIG. 28, the data communication system according to the twelfth embodiment has a configuration that a data transmitting apparatus 19105, a data receiving apparatus 10201 and a sub data receiving apparatus 19207 are connected via a transmission path 110 and a branching part 235. In comparison with the eleventh embodiment (FIG. 26), the data communication system according to the twelfth embodiment is different in the point that the branching part 235 and the sub data receiving apparatus 19207 are further provided. Here, although omitted in FIG. 28, the multilevel decoding part 212 includes a second multilevel code generating part 212a and a decision part 212b. The data communication system according to the twelfth embodiment is described below. Here, the configuration of the present embodiment is similar to that of the eleventh embodiment (FIG. 26). Thus, blocks that perform the same operation are designated by the same reference numerals, and their description is omitted.

In FIG. 28, the data transmitting apparatus 19105 transmits the modulated signal 14 modulated from the multilevel signal shown in FIG. 27. The branching part 235 branches the modulated signal 14 transmitted via the transmission path 110 into m signals (m is an integer greater than or equal to 2; m=2 in the example of FIG. 28). The data receiving apparatus 10201 is provided in correspondence to n modulated signals (n is an integer smaller than or equal to m; n=1 in the example of FIG. 28) among the m modulated signals outputted from the branching part 520. In the durations A and C, on the basis of the second key information 16 shared as the same key as the first key information 11, the data receiving apparatus 10201 demodulates and decodes the modulated signal, and regenerates the information data 18. Here, the data receiving apparatus 10201 may identify the binary signal in the duration B.

The sub data receiving apparatus 19207 is provided in correspondence to m−n modulated signals (m−n=2−1=1 in the example of FIG. 28) among the m modulated signals outputted from the branching part 235. The sub demodulating part 236 demodulates the inputted modulated signal and regenerates the multi level signal 15. On the basis of a predetermined fixed threshold, the decision part 237 identifies the multilevel signal 15 outputted from the demodulating part 236, and regenerates the information data (partial information data 68) solely in the duration B shown in FIG. 27.

Here, in FIG. 28, the data communication system has a configuration that the number of branches in the branching part 235 is 2 (i.e., m=2), and that a data receiving apparatus 10201 is provided in correspondence to one modulated signal (i.e., n=1) branched in the branching part 235 while a sub data receiving apparatus 19207 is provided in correspondence to the other modulated signal (i.e., m−n=1). However, the configuration of the data communication system is not limited to this. That is, m and n may be set to be arbitrary numbers as long as m>n.

As described above, according to the present embodiment, information data to be transmitted is encoded as a multilevel signal. Then, critical degradation is imparted to the received signal quality at the time of wiretapping by a third person, so that a security communication channel solely for a particular receiving person is ensured. At the same time, the multi valued number is reduced appropriately, so that simultaneous transmission communication to many and unspecified receiving persons is realized selectively. By virtue of this, a concealed communication service and a communication service such as simultaneous transmission communication and broadcasting can be provided in a mixed manner by using the same modulating and demodulating system and transmission system. This provides an efficient communication system.

### Thirteenth Embodiment

FIG. 29 is a block diagram showing a configuration of a data communication system according to a thirteenth embodiment of the present invention. In FIG. 29, the data communication system according to the thirteenth embodiment has a configuration that a data transmitting apparatus 19108, a plurality of data receiving apparatuses 10201a to 10201b and a sub data receiving apparatus 19207 are connected via a transmission path 110 and a branching part 235. In comparison with the twelfth embodiment (FIG. 28), the data transmitting apparatus 19108 further comprises a key information selecting part 136. Here, although omitted in FIG. 29, the multilevel decoding part 212 includes a second multilevel code generating part 212a and a decision part 212b. The data communication system according to the thirteenth embodiment is described below. Here, the configuration of the present embodiment is similar to that of the twelfth embodiment (FIG. 28). Thus, blocks that perform the same operation are designated by the same reference numerals, and their description is omitted.

In FIG. 29, the key information selecting part 136 selects any one from n pieces of key information defined in advance (n=2 in the example of FIG. 29; the n pieces of key information are the first key information 11a and the third key information 11b). On the basis of the selected key information, the multilevel encoding part 111 generates the multilevel signal 13 as shown in FIG. 27. The data receiving apparatuses 10201a and 10201b of n units are provided in correspondence to the n modulated signals among the m modulated signals branched by the branching part 235 (m=3 and n=2 in the example of FIG. 29). On the basis of the second key information 16a shared as the same key as the first key information 11a, the data receiving apparatus 10201a demodulates and decodes the modulated signal, and regenerates the information data 18a. Similarly, on the basis of the fourth key information 16b shared as the same key as the first key information 11a, the data receiving apparatus 10201b demodulates and decodes the modulated signal, and regenerates the information data 18b.

Specifically, in FIG. 27, when the data transmitting apparatus 19108 generates a multilevel signal 13 by using the first key information 11a in the duration A, the data receiving apparatus 10201a demodulates the modulated signal inputted in the duration A, and regenerates the information data 18a by using the second key information 16a. Further, when the data transmitting apparatus 19108 generates a multilevel signal 13 by using the third key information 11b in the duration C, the data receiving apparatus 10201b demodulates the modulated signal inputted in the duration C, and regenerates the information data 18b by using the fourth key information 16b. Here, the data receiving apparatuses 10201a and 10201b may demodulate the modulated signal inputted in the duration B so as to regenerate the partial information data 58.

The sub data receiving apparatus 19207 is provided in correspondence to m−n modulated signals (m−n=3−2=1 in the example of FIG. 29) among the m modulated signals outputted from the branching part 235. The sub demodulating part 236 demodulates the inputted modulated signal and regenerates the multilevel signal 15. On the basis of a predetermined fixed threshold, the decision part 237 identifies the multilevel signal 15 outputted from the corresponding demodulating part 236, and regenerates the information data (partial information data 58) solely in the duration B shown in FIG. 27.

Here, in FIG. 29, the data communication system has a configuration that the number of branches in the branching part 235 is 3 (i.e., m=3), and that two data receiving apparatuses 10201a and 10201b are provided in correspondence to two modulated signals (i.e., n=2) branched in the branching part 235 while a sub data receiving apparatus 19207 is provided in correspondence to the other modulated signal (i.e., m−n=1). However, the configuration of the data receiving apparatus is not limited to this. That is, m and n may be set to be arbitrary numbers as long as m−n.

As described above, according to the present embodiment, information data to be transmitted is encoded as a multilevel signal, and critical degradation is imparted to the received signal quality at the time of wiretapping by a third person. Further, plural pieces of key information are prepared and switched in the use, so that security communication channels solely for a plurality of particular receiving persons are ensured individually. Further, the multi valued number is reduced appropriately, so that simultaneous transmission communication to many and unspecified receiving persons is realized selectively. By virtue of this, a concealed communication service and a communication service such as simultaneous transmission communication and broadcasting can be provided in a mixed manner by using the same modulating and demodulating system and transmission system. This provides an efficient communication system.

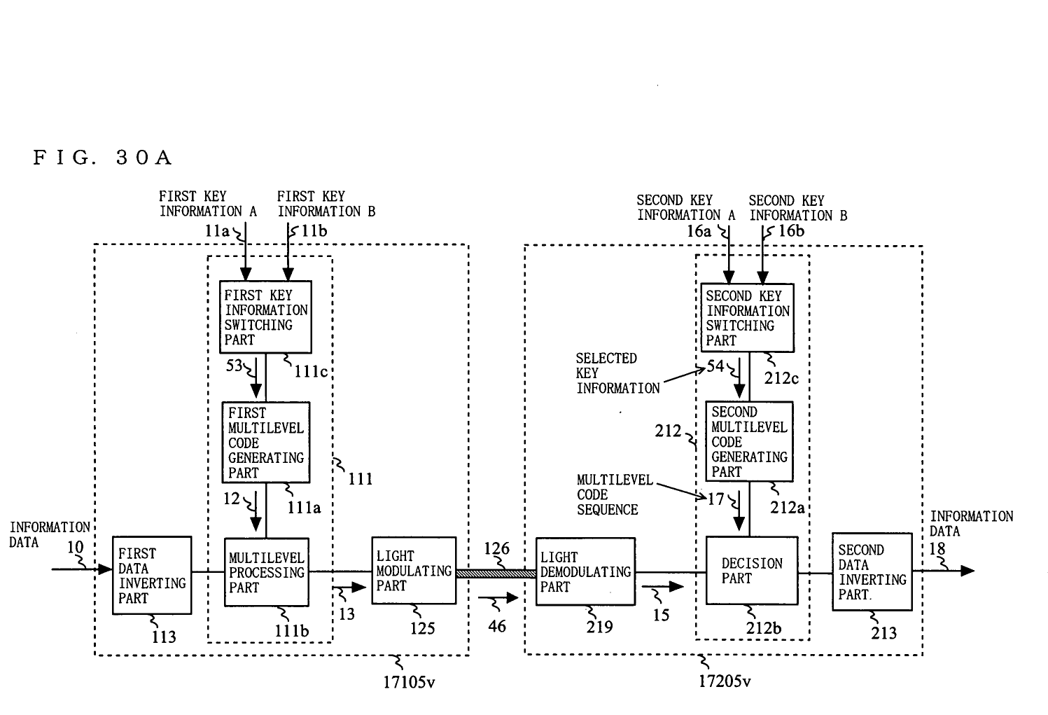

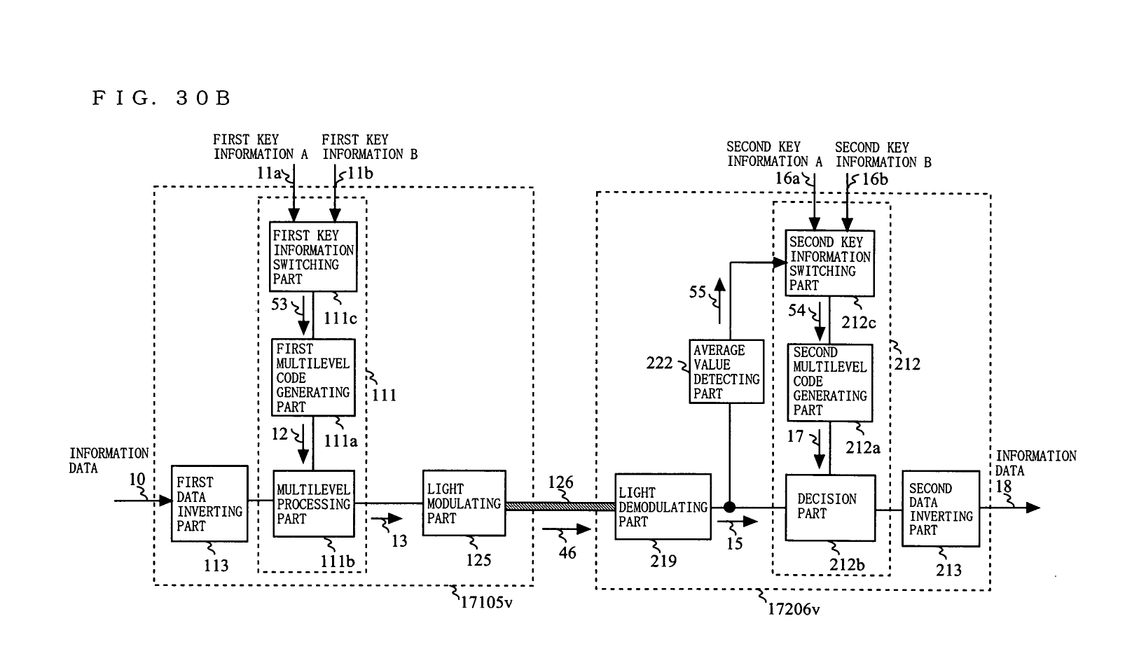

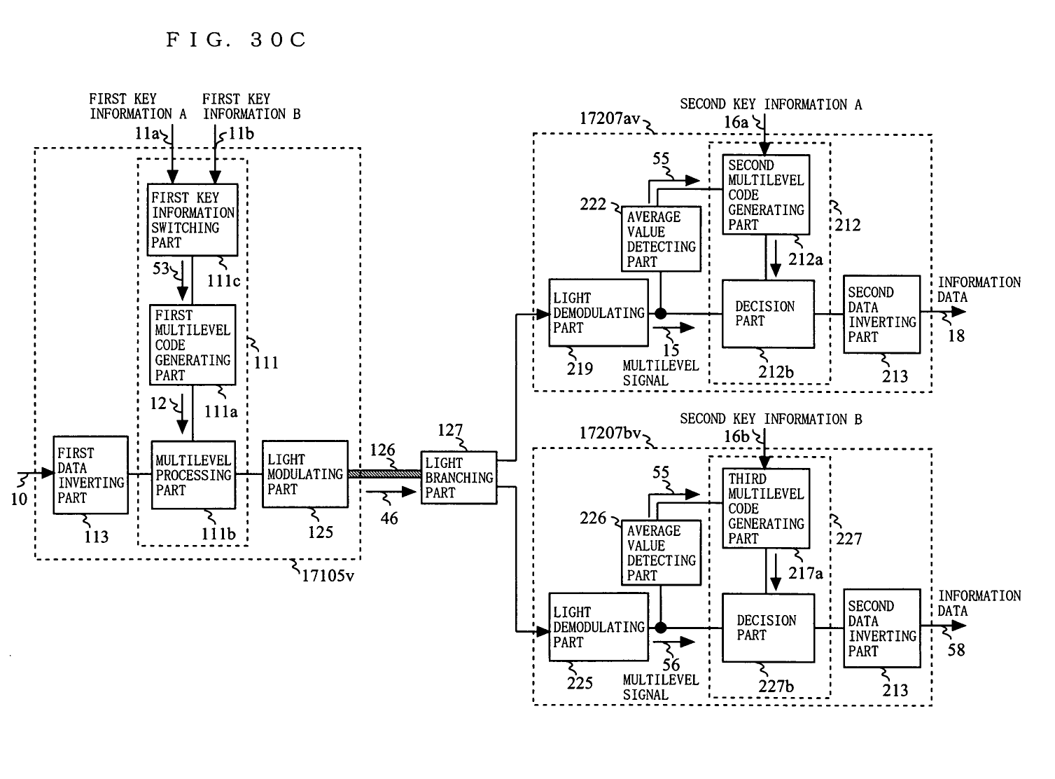

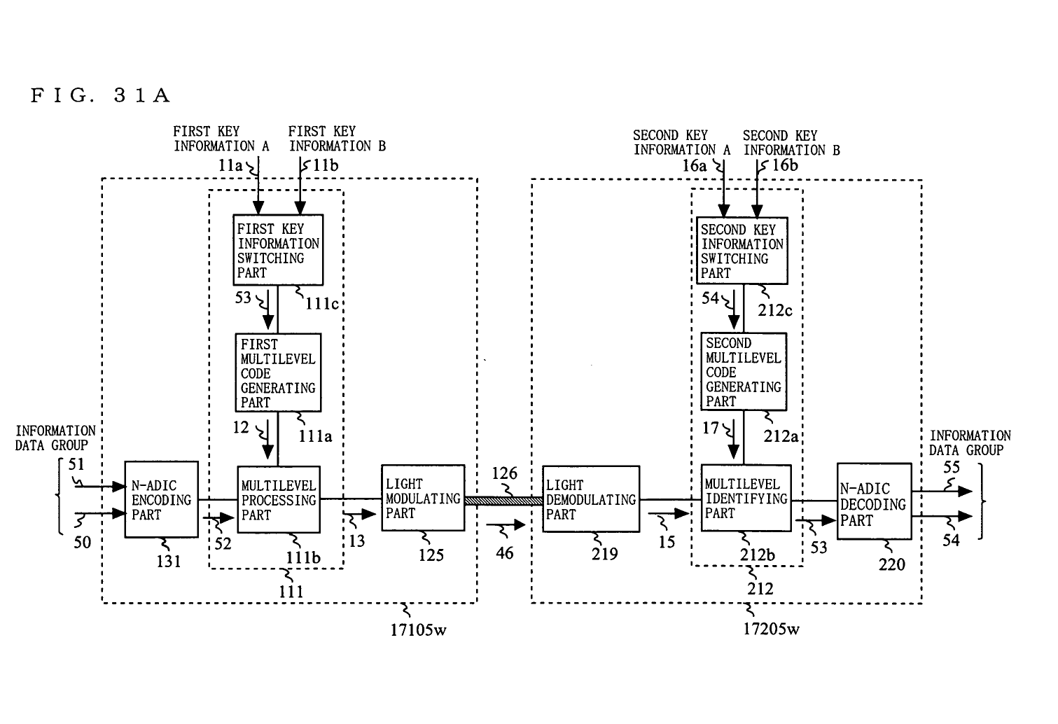

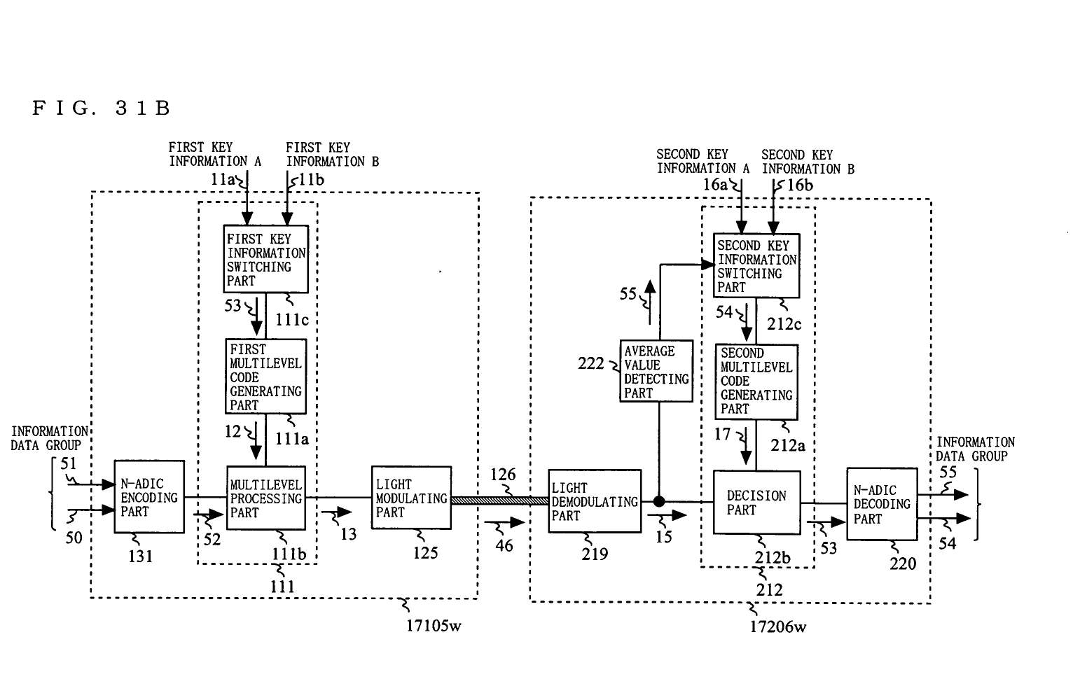

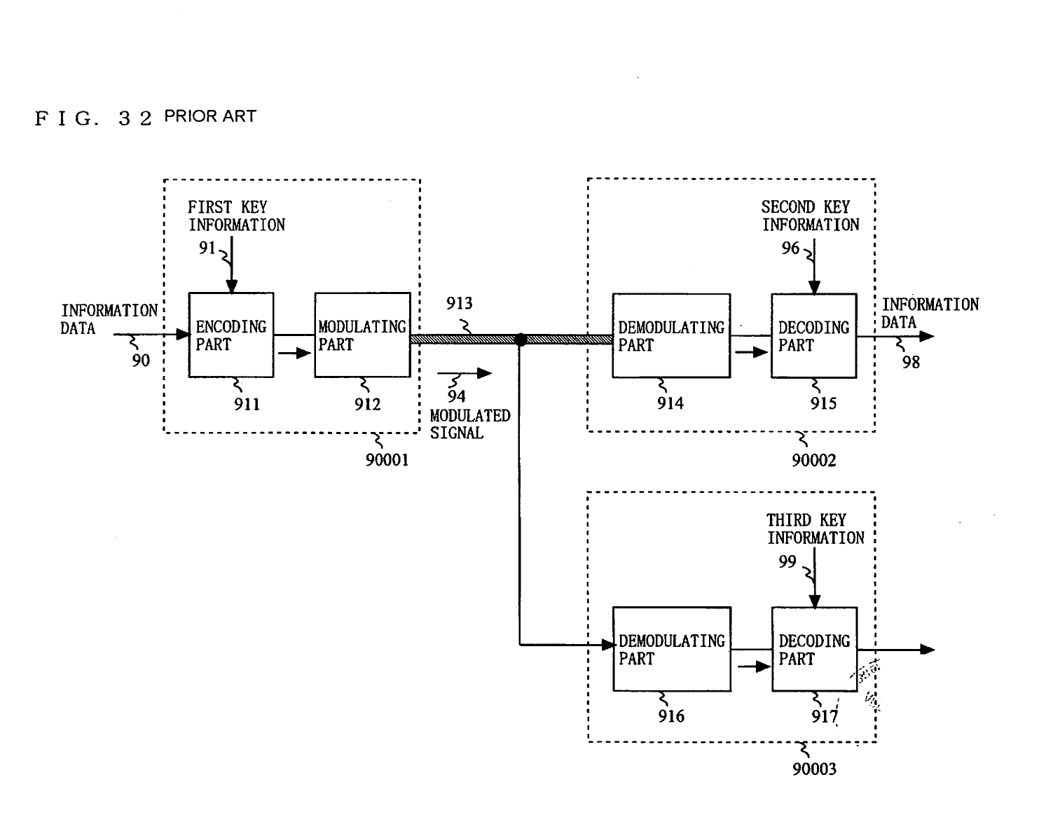

Here, the data communication system according to the second to the twelfth embodiments described above may have a configuration that the features of the embodiments are combined with each other. For example, the data communication system according to the fifth to the seventh embodiments may have the features of the second embodiment (see, for example, FIGS. 30A to 30C). For example, the data communication system according to the fifth to the sixth embodiments may have the features of the eighth embodiment (see, for example, FIGS. 31A to 31B).

Further, the above-mentioned processing performed individually by the data transmitting apparatus, the data receiving apparatus and the data communication system according to the first to the twelfth embodiments may be recognized as a data transmission method, a data receiving method and a data communication method that provide a series of procedure.

Further, the data communication method, the data receiving method and the data communication method described above may be realized when predetermined program data that is stored in a storage device (such as a ROM, a RAM and a hard disk) and that can implement the above-mentioned procedure is interpreted and executed by a CPU. In this case, the program data may be introduced into the storage device via a storage medium, or may be executed directly from the storage medium. Here, the storage medium indicates a semiconductor memory (such as a ROM, a RAM and a flash memory), a magnetic disk memory (such as a flexible disk and a hard disk), an optical disk memory (such as a CD-ROM, a DVD and a BD), a memory card or the like. Further, the concept of the storage medium includes a communication media such as a telephone line and a carrying path.

### INDUSTRIAL APPLICABILITY

The data communication system according to the present invention is useful as a security and concealed communication system in which wiretapping and interception are avoided.

1. A data transmitting apparatus for performing encrypted communication, comprising:
a multilevel encoding part for receiving predetermined key information and information data, and generating a multilevel signal that varies in a signal level substantially in a random number manner; and
a modulating part for generating a modulated signal of a predetermined modulation scheme on the basis of the multilevel signal, wherein
the predetermined key information is a plurality of key information, and wherein
the multilevel encoding part includes:
a key information switching part for switching and outputting the plurality of key information at a predetermined timing;
a multilevel code generating part for generating a multilevel code sequence which varies in a signal level substantially in a random number manner and in which the average values of the signal levels are different in respective key information outputted from the key information switching part, on the basis of the key information outputted from the key information switching part; and
a multilevel processing part for combining the multilevel code sequence and the information data in accordance with predetermined processing, and generating a multilevel signal having a level corresponding to a combination of the two signal levels.

2. (canceled)

3. The data transmitting apparatus as claimed in claim 1, wherein the key information switching part switches and outputs the plurality of key information to the multilevel code generating part at predetermined time intervals.

4. The data transmitting apparatus as claimed in claim 1, wherein the key information switching part stores in advance a sequence of switching the plurality of key information, and switches and outputs the plurality of key information to the multilevel code generating part in accordance with the stored sequence.

5. The data transmitting apparatus as claimed in claim 3, wherein the key information switching part switches the plurality of key information at time intervals shorter than a response speed of a gain change of an erbium doped fiber amplifier.

6. A data receiving apparatus for performing encrypted communication, comprising:
a demodulating part for demodulating a modulated signal of a predetermined modulation scheme and outputting it as a multilevel signal; and
a multilevel decoding part for receiving predetermined key information and the multilevel signal, and outputting information data, wherein
the predetermined key information is a plurality of key information, and wherein
the multilevel decoding part includes:
a key information switching part for switching and outputting the plurality of key information at a predetermined timing;
a multilevel code sequence generating part for generating a multilevel code sequence which varies in a signal level substantially in a random number manner and in which the average values of the signal levels are different in respective key information outputted from the key information switching part, on the basis of the key information outputted from the key information switching part; and
a decision part for receiving the multilevel signal, and deciding the logic of the information data on the basis of the multilevel code sequence and outputting the information data.

7. (canceled)

8. The data receiving apparatus as claimed in claim 6, wherein the key information switching part switches and outputs the plurality of key information to the multilevel code sequence generating part at predetermined time intervals.

9. The data receiving apparatus as claimed in claim 8, further comprising an average value detecting part for calculating an average value of the multilevel signal level for each predetermined time, and determining key information for regenerating the information data, as regeneration key information by using the calculated average value and the average value of the levels of the multilevel signal that appears in correspondence to each of the plurality of key information.

10. The data receiving apparatus as claimed in claim 9, wherein
the average value detecting part includes:
an integration circuit for outputting an integration value obtained by integrating the level of the multilevel signal for each predetermined time;
an average value calculating part for calculating an average value of the multilevel signal level from the integration value; and
a control signal generating part that holds in advance an average value of the levels of the multilevel signal appearing in correspondence to each of the plurality of key information, then determines as the regeneration key information the key information of the case that the absolute value of a difference between the calculated average value and the average value held in advance becomes the minimum, and generates a control signal for uniquely identifying the regeneration key information, and wherein
the key information switching part outputs key information identified with the control signal, as the regeneration key information to the multilevel code sequence generating part.

11. The data receiving apparatus as claimed in claim 6, wherein the key information switching part stores in advance a sequence of switching and outputting the plurality of key information, and switches and outputs the plurality of key information to the multilevel code sequence generating part in accordance with the stored sequence.

12. The data receiving apparatus as claimed in claim 8, further comprising an average value detecting part for calculating an average value of the multilevel signal level for each predetermined time, and determining key information for regenerating the information data, as regeneration key information by using the calculated average value, the sequence stored in advance and the average value of the levels of the multilevel signal that appears in correspondence to each of the plurality of key information.

13. The data receiving apparatus as claimed in claim 12, wherein
the average value detecting part includes:
an integration circuit for outputting an integration value obtained by integrating the level of the multilevel signal for each predetermined time;
an average value calculating part for calculating an average value of the multilevel signal level from the integration value; and
a control signal generating part that holds in advance an average value of the levels of the multilevel signal appearing in correspondence to each of the plurality of key information, then selects key information of the case that the absolute value of a difference between the calculated average value and the average value held in advance becomes the minimum, then determines, as being the regeneration key information, key information to be used next to the key information selected from the sequence stored in advance, and generates a control signal for uniquely identifying the regeneration key information, and wherein
the key information switching part outputs key information identified with the control signal, as the regeneration key information to the multilevel code sequence generating part.

14. The data receiving apparatus as claimed in claim 6, further comprising
an average value detecting part that calculates an average value of the multilevel signal level for each predetermined time and that, when the calculated average value is a value within a predetermined range, generates a control signal for instructing output of the multilevel code sequence, and outputs it to the multilevel code sequence generating part, wherein
the multilevel code sequence generating part generates the multilevel code sequence only at the time of receiving the control signal.

15. The data receiving apparatus as claimed in claim 14, wherein
the average value detecting part includes:
an integration circuit for outputting an integration value obtained by integrating the level of the multilevel signal for each predetermined time;
an average value calculating part for calculating an average value of the levels of the multilevel signal from the integration value; and
a control signal generating part for generating the control signal when the level of the calculated average value falls within a predetermined range.

16. A data communication system in which a data transmitting apparatus and a data receiving apparatus perform encrypted communication, wherein
the data transmitting apparatus comprises:
a multilevel encoding part for receiving predetermined first key information and information data, and generating a first multilevel signal that varies in a signal level substantially in a random number manner; and
a modulating part for generating a modulated signal of a predetermined modulation scheme on the basis of the first multilevel signal, wherein
the first predetermined key information is a plurality of key information, wherein
the multilevel encoding part includes:
a first key information switching part for switching and outputting the plurality of key information at a predetermined timing;
a first multilevel code generating part for generating a first multilevel code sequence which varies in a signal level substantially in a random number manner and in which the average values of the signal levels are different in respective key information outputted from the first key information switching part, on the basis of the key information outputted from the first key information switching part; and
a multilevel processing part for combining the first multilevel code sequence and the information data in accordance with predetermined processing, and converting it into the first multilevel signal having a level corresponding to a combination of the two signal levels, wherein
the data receiving apparatus comprises:
a demodulating part for demodulating a modulated signal of a predetermined modulation scheme and outputting a second multilevel signal; and
a multilevel decoding part for receiving predetermined second key information and the second multilevel signal and outputting information data, wherein
the second key information is a plurality of key information, and wherein
the multilevel decoding part includes:
a second key information switching part for switching and outputting the plurality of key information at a predetermined timing;
a second multilevel code generating part for generating a second multilevel code sequence which varies in a signal level substantially in a random number manner and in which the average values of the signal levels are different in respective key information outputted from the second key information switching part, on the basis of the key information outputted from the second key information switching part; and
a decision part for receiving the second multilevel signal, and deciding the logic of the information data on the basis of the second multilevel code sequence, and outputting the information data.

17. (canceled)

18. The data communication system as claimed in claim 16, wherein the first key information switching part switches and outputs the plurality of key information to the first multilevel code generating part at predetermined time intervals.

19. The data communication system as claimed in claim 16, wherein the first key information switching part stores in advance a sequence of switching the plurality of key information, and switches and outputs the plurality of key information to the first multilevel code generating part in accordance with the stored sequence.

20. The data communication system as claimed in claim 18, wherein the first key information switching part switches the plurality of key information at time intervals shorter than a response speed of a gain change of an erbium doped fiber amplifier.

21. The data communication system as claimed in claim 16, wherein the second key information switching part switches and outputs the plurality of key information to the second multilevel code sequence generating part at predetermined time intervals.

22. The data communication system as claimed in claim 21, wherein
the data receiving apparatus further comprises
an average value detecting part for calculating an average value of the multilevel signal level for each predetermined time, and determining key information for regenerating the information data, as regeneration key information by using the calculated average value and the average value of the levels of the multilevel signal that appears in correspondence to each of the plurality of key information.

23. The data communication system as claimed in claim 22, wherein
the average value detecting part includes:
an integration circuit for outputting an integration value obtained by integrating the level of the multilevel signal for each predetermined time;
an average value calculating part for calculating an average value of the multilevel signal level from the integration value; and
a control signal generating part that holds in advance an average value of the levels of the multilevel signal appearing in correspondence to each of the plurality of key information, then determines as the regeneration key information the key information of the case that the absolute value of a difference between the calculated average value and the average value held in advance becomes the minimum, and generates a control signal for uniquely identifying the regeneration key information, and wherein
the key information switching part outputs key information identified with the control signal, as the regeneration key information to the multilevel code sequence generating part.

24. The data communication system as claimed in claim 16, wherein the second key information switching part stores in advance a sequence of switching and outputting the plurality of key information, and switches and outputs the plurality of key information to the second multilevel code sequence generating part in accordance with the stored sequence.

25. The data communication system as claimed in claim 21, wherein
the data receiving apparatus further comprises
an average value detecting part for calculating an average value of the multilevel signal level for each predetermined time, and determining key information for regenerating the information data, as regeneration key information by using the calculated average value, the sequence stored in advance and the average value of the levels of the multilevel signal that appears in correspondence to each of the plurality of key information.

26. The data communication system as claimed in claim 25, wherein
the average value detecting part includes:
an integration circuit for outputting an integration value obtained by integrating the level of the multilevel signal for each predetermined time;
an average value calculating part for calculating an average value of the multilevel signal level from the integration value; and
a control signal generating part that holds in advance an average value of the levels of the multilevel signal appearing in correspondence to each of the plurality of key information, then selects key information of the case that the absolute value of a difference between the calculated average value and the average value held in advance becomes the minimum, then determines, as being the regeneration key information, key information to be used next to the key information selected from the sequence stored in advance, and generates a control signal for uniquely identifying the regeneration key information, and wherein
the second key information switching part outputs key information identified with the control signal, as the regeneration key information to the second multilevel code sequence generating part.

27. The data communication system as claimed in claim 16, wherein
the data receiving apparatus further comprises
an average value detecting part that calculates an average value of the multilevel signal level for each predetermined time and that, when the calculated average value is a value within a predetermined range, generates a control signal for instructing output of the multilevel code sequence, and outputs it to the second multilevel code sequence generating part, wherein
the second multilevel code sequence generating part generates the second multilevel code sequence only at the time of receiving the control signal.

28. The data communication system as claimed in claim 27, wherein
the average value detecting part includes:
an integration circuit for outputting an integration value obtained by integrating the level of the multilevel signal for each predetermined time;
an average value calculating part for calculating an average value of the levels of the multilevel signal from the integration value; and
a control signal generating part for generating the control signal when the level of the calculated average value falls within a predetermined range.

29. The data transmitting apparatus as claimed in claim 4, wherein the key information switching part switches the plurality of key information at time intervals shorter than a response speed of a gain change of an erbium doped fiber amplifier.

30. The data communication system as claimed in claim 19, wherein the first key information switching part switches the plurality of key information at time intervals shorter than a response speed of a gain change of an erbium doped fiber amplifier.
